(19) United States
(12) Patent Application Publication
(10) Pub. No.: US 2020/0333839 A1
(43) Pub. Date: Oct. 22, 2020

(54) DISPLAY POSITIONING SYSTEM

(71) Applicant: Tangible Play, Inc., Palo Alto, CA (US)

(72) Inventors: Vivek Vidyasagaran, Palo Alto, CA (US); Jon Dukerschein, Pacifica, CA (US); Mark Solomon, San Jose, CA (US); Ariel Zekelman, Palo Alto, CA (US); Vivardhan Kanoria, Mountain View, CA (US); Felix Hu, Menlo Park, CA (US)

(21) Appl. No.: 16/852,836

(22) Filed: Apr. 20, 2020

Related U.S. Application Data
(60) Provisional application No. 62/836,023, filed on Apr. 18, 2019.

(51) Int. Cl. G06F 1/16; A47B 19/10

(52) U.S. Cl. CPC G06F 1/1632; A47B 19/10

(57) ABSTRACT

A display positioning system including a stand assembly is described. In an example implementation, the stand assembly includes a base structure including one or more foldable base components that are detachably assembleable to form the base structure; and one or more foldable device supporting panels detachably coupleable to the base structure, a device supporting panel from the one or more foldable device supporting panels including a device slot adapted to receive a computing device.

### BACKGROUND

The present disclosure relates to display positioning systems. In a more particular example, the disclosure relates to display positioning systems including a stand assembly.

A display positioning system often includes a stand for placing a computing device on the stand, thereby allowing a user to view a display of the computing device without holding the computing device in his or her hands. However, the existing stands are usually expensive due to their complicated manufacturing process and high-cost material. Moreover, the existing stands are often integrally formed as a single unit and usually occupy a relatively large space. These existing stands are expensive to manufacture and sell. Furthermore, as a result of their size, it is usually inconvenient for a user to carry these stands as the user transports between various locations (e.g., from home to school, etc.).

### SUMMARY

According to one innovative aspect of the subject matter in this disclosure, a stand assembly is described. The stand assembly includes a base structure including one or more foldable base components that are detachably assembleable to form the base structure; and one or more device supporting panels detachably coupleable to the base structure, a device supporting panel from the one or more device supporting panels including a device slot adapted to receive a computing device.

Implementations may include one or more of the following features. The stand assembly where the one or more foldable base components of the base structure include a plurality of platform portions including at least a first platform portion detachably coupleable to a second platform portion to form a base platform from the plurality of platform portions, the base platform including one or more panel slots adapted to receive the one or more device supporting panels. The stand assembly where the device supporting panel includes a base slot adapted to compatibly accommodate the base platform when the device supporting panel is inserted into a panel slot on the base platform; and the base slot of the device supporting panel retains a relative position between the plurality of platform portions of the base platform when the base platform is accommodated in the base slot. The stand assembly where the second platform portion includes a gripping slot aligned with a panel slot from the one or more panel slots, the gripping slot and the panel slot retaining the device supporting panel in the panel slot when the device supporting panel is inserted into the panel slot. The stand assembly where the one or more foldable base components of the base structure include a front panel extending from a platform portion of a base platform; and a visual indicator positioned on the front panel and located within a field of view of a video capture device of the computing device when the computing device is situated in one or more device slots of the one or more device supporting panels. The stand assembly where the one or more foldable base components of the base structure include a front panel extending from a platform portion of a base platform; and a front panel tab extending from the front panel and positionable to align with a panel slot on the base platform. The stand assembly where the front panel tab is situated between a first portion and a second portion of the device supporting panel when the device supporting panel is inserted into the panel slot on the base platform and the panel slot on the base platform holds the first portion and the second portion of the device supporting panel against one another. The stand assembly where the device supporting panel has a back surface of the device slot that is higher than a front surface of the device slot; and at least a portion of a back surface of the computing device rests against the back surface of the device slot and at least a portion of a device edge of the computing device rest against one or more of a bottom surface of the device slot and the front surface of the device slot when the computing device is situated in the device slot. The stand assembly where the device slot of the device supporting panel includes a retaining element positioned on an edge of the device slot, the retaining element including a retaining material. The stand assembly where the base structure includes a slot adapted to receive an adapter support protrusion; and the adapter support is located within a slot of a camera adapter when the camera adapter is placed on the adapter support protrusion. The stand assembly where the adapter support compatibly fits in the slot of the camera adapter. The stand assembly where the one or more foldable base components of the base structure and the one or more device supporting panels are made from one or more of cardboard, paperboard, and plastic.

Generally another innovative aspect of the subject matter described in this disclosure may be embodied in a method that includes capturing, using a video capture device of a computing device, a video stream that includes an activity scene of a physical activity surface, the computing device being placed on a stand assembly situated on the physical activity surface; detecting in the video stream, using a detector executable on the computing device, a first stand component of the stand assembly; determining a relative position of the first stand component of the stand assembly relative to a reference point associated with the stand assembly; determining that the first stand component is incorrectly assembled based on the relative position of the first stand component relative to the reference point; determining an assembling instruction associated with of the first stand component; and displaying the assembling instruction on the computing device.

Implementations may include one or more of the following features. The method where the stand assembly includes a plurality of stand components that are detachably assembleable to form the stand assembly based on a set of assembling instructions. The method where the reference point associated with the stand assembly includes one or more of a second stand component of the stand assembly; a visual indicator positioned on a front panel of the stand assembly; and a panel marker positioned on a device supporting panel of the stand assembly. The method that includes determining a component orientation of the first stand component, and where determining that the first stand component is incorrectly assembled is further based on the component orientation of the first stand component.

Generally another innovative aspect of the subject matter described in this disclosure may be embodied in a foldable stand assembly that includes a base structure including a foldable base platform, the foldable base platform including a first panel slot and a second panel slot, a first foldable device supporting panel adapted to be inserted into the first panel slot of the foldable base platform to form the foldable stand assembly, and a second foldable device supporting panel adapted to be inserted into the second panel slot of the foldable base platform to form the foldable stand assembly.

Implementations may include one or more of the following features. The foldable stand assembly where the base structure includes a first panel tab on the base structure, the first panel tab configured to be situated between a first portion and a second portion of the first device supporting panel when the first device supporting panel is inserted into the first panel slot; and a second panel tab on the base structure, the second panel tab configured to be situated between a first portion and a second portion of the second device supporting panel when the second device supporting panel is inserted into the second panel slot. The foldable stand assembly wherein the first foldable device panel and the second foldable device panel form a device slot adapted to receive a stably position a bottom edge of a computing device. The foldable stand assembly where the plurality of stand components of the foldable stand assembly are made from one or more of cardboard, paperboard, and plastic.

Other implementations of one or more of these aspects and other aspects described in this document include corresponding systems, apparatus, and computer programs, configured to perform the actions of the methods, encoded on computer storage devices. The above and other implementations are advantageous in a number of respects as articulated through this document. Moreover, it should be understood that the language used in the present disclosure has been principally selected for readability and instructional purposes, and not to limit the scope of the subject matter disclosed herein.

### BRIEF DESCRIPTION OF THE DRAWINGS

The disclosure is illustrated by way of example, and not by way of limitation in the figures of the accompanying drawings in which like reference numerals are used to refer to similar elements.

FIGS. 1 and 2 respectively illustrate an example stand assembly in an assembled state from different perspectives.

FIG. 3 illustrate an example display positioning system that includes a stand assembly in an assembled state with a computing device situated on the stand assembly.

FIG. 4 is a block diagram illustrating an example computer system that is used with a display positioning system.

FIG. 5 is a block diagram illustrating an example computing device.

FIG. 6 is a flowchart of an example method for processing a video stream.

FIG. 7 is a flowchart of an example method for providing an assembling instruction associated with a stand assembly.

FIGS. 8A-8C respectively illustrate an example base structure, an example device supporting panel, and an example adapter support in a disassembled state.

FIGS. 9 and 10 respectively illustrate an example base structure in an assembled state from different perspectives.

FIGS. 11A and 11B respectively illustrate a side view of an example base structure in an assembled state from different perspectives.

FIGS. 12A-12C respectively illustrate an example of two device supporting panels and an example adapter support in an assembled state.

FIGS. 13A-13E respectively illustrate another embodiment of an example stand assembly

### DETAILED DESCRIPTION

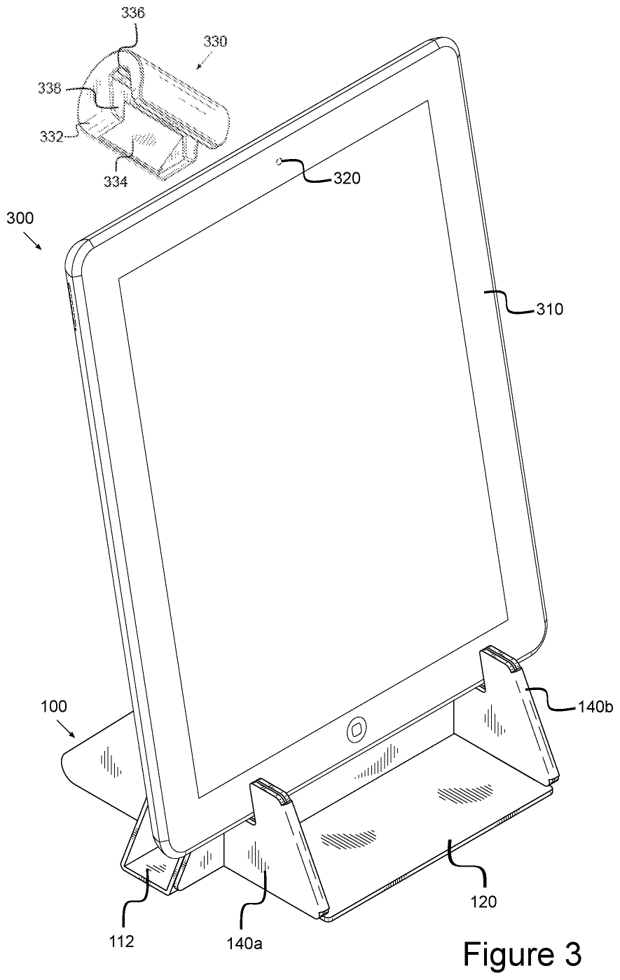

FIG. 3 illustrates an example display positioning system 300. As depicted, the display positioning system 300 may include a stand assembly 100 and a camera adapter 330. In some embodiments, the stand assembly 100 may be situated on a physical activity surface and may be configured to receive a computing device 310 and position the computing device 310 in an upright and/or angled position. The camera adapter 330 may be configured to situate on a device edge of the computing device 310 and over a video capture device 320 of the computing device 310 to redirect the field of view of the video capture device 320. By using the camera adapter 330 to redirect the field of view of the video capture device 320, the video capture device 320 can capture video stream and/or images of objects and user interactions on an activity scene of the physical activity surface. The activity scene may be a portion of the physical activity surface that is located within the field of view of the video capture device 320.

In some embodiments, the stand assembly 100 may include a plurality of stand components. In some embodiments, the stand components may be detachably assembled to form the stand assembly 100, and the stand assembly 100 may be broken down into the stand components as needed. In some embodiments, the stand components of the stand assembly 100 may be designed to reduce the size of the stand assembly 100, such as by having a substantially flat shape or being unfolded to flatten out, and therefore the stand components may occupy a much lower amount of space when they are separated individually as compared to when they are assembled to form the stand assembly 100. Thus, as the stand assembly 100 can be flexibly disassembled when it is not in use to reduce the space occupied by its stand components, the storage, packaging, shipping, or carrying of the stand components can be facilitated. In some embodiments, the stand components of the stand assembly 100 may be made from one or more inexpensive materials (e.g., cardboard, paperboard, low-cost plastic, low-cost wood, etc.), thereby simplifying the manufacturing process and lowering the product cost of the stand assembly 100.

In some embodiments, the stand assembly 100 may be provided as a trial product for users. This implementation is advantageous, because it enables a user to experience the stand assembly 100 being used with various computing devices 310 and/or with various activity applications implemented on the computing device 310 at an optimally low cost, and the user may then decide whether or not to purchase a more expensive version of the stand assembly 100.

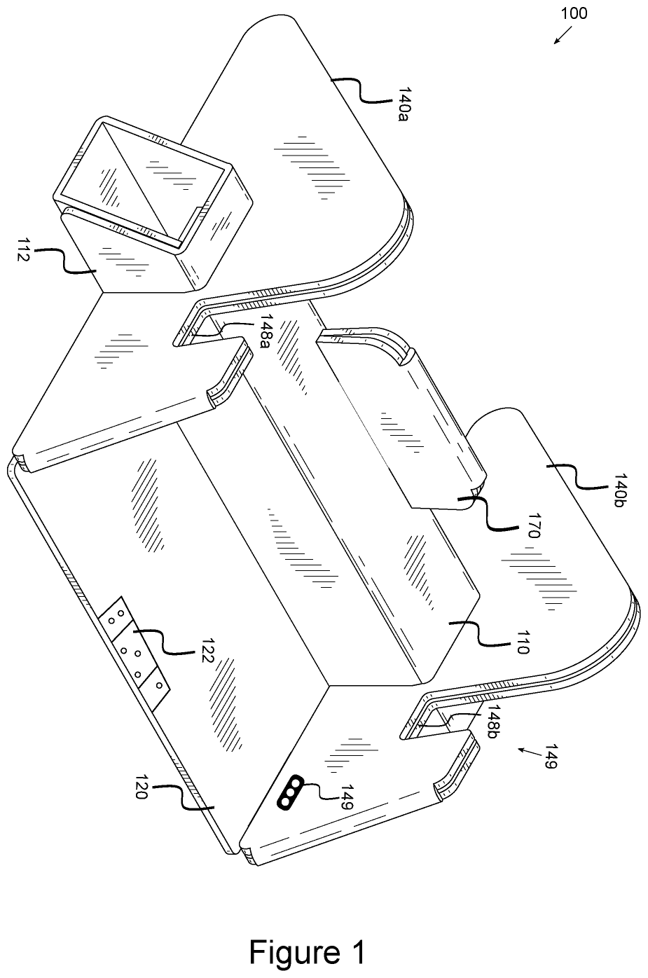

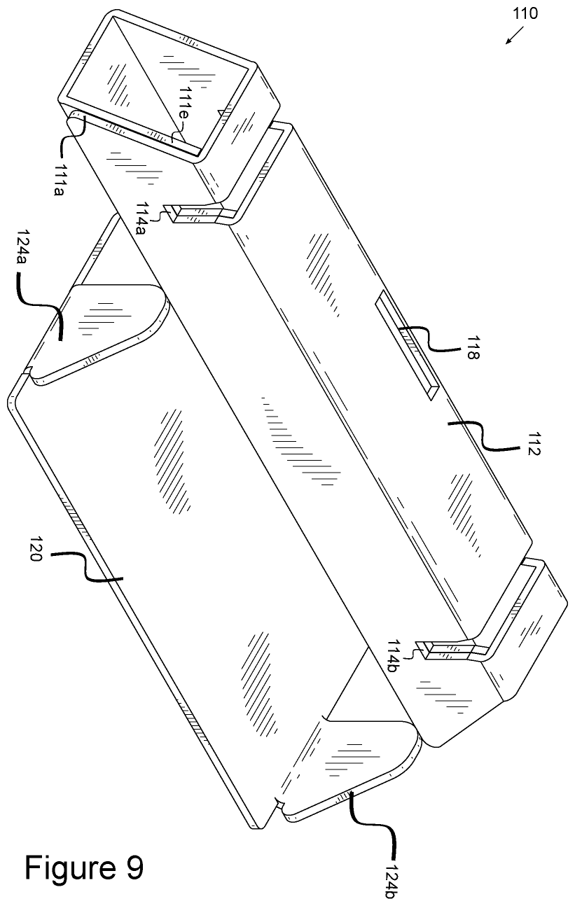

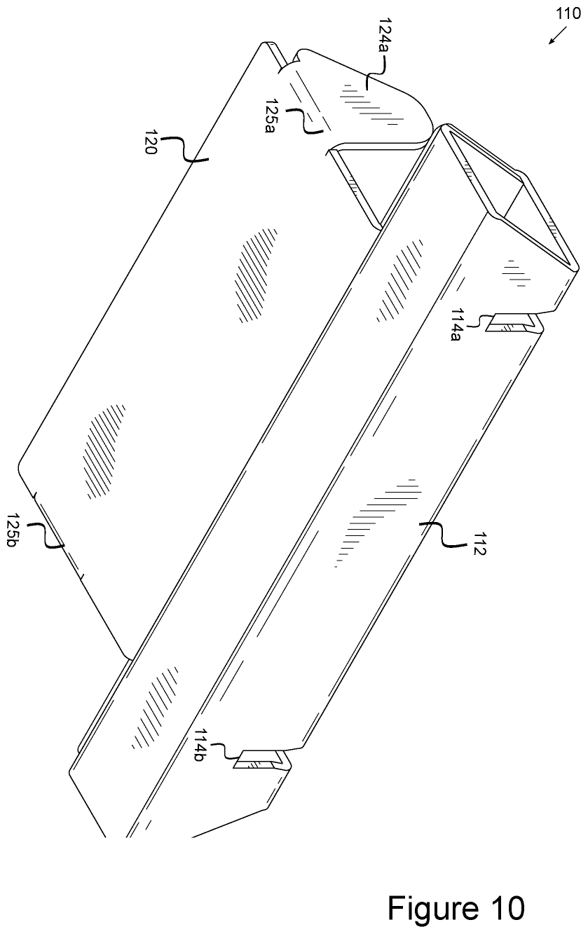

As discussed above, the stand assembly 100 may be dynamically assembled from the plurality of stand components. Examples of the stand assembly 100 in the assembled state are illustrated in FIGS. 1, 2, and 13E. As depicted, the stand assembly 100 may include a base structure 110, one or more device supporting panels, such as panel 140a, 140b, etc. (also herein referred to individually or collectively as 140), and an adapter support 170. In some embodiments, the base structure 110 may include a base platform 112 and a front panel 120 that are formed by one or more foldable base components detachably assembled to one another. As depicted in FIGS. 9 and 10, the base platform 112 may include one or more panel slots 114 adapted to receive the one or more device supporting panels 140. In some embodiments, the stand assembly 100 may include multiple (e.g., two or more) device supporting panels 140 corresponding to multiple panel slots 114 on the base platform 112. Each device supporting panel 140 may be removably insertable into a panel slot 114. Alternatively, the stand assembly 100 may include one device supporting panel 140 and multiple panel slots 114 on the base platform 112. The device supporting panel 140 may be divided into multiple portions at one or more folding regions, and these portions may be flexibly rearranged relative to one another so that two or more portions of the device supporting panel 140 may be simultaneously inserted into the panel slots 114.

In some embodiments, each device supporting panel 140 may include a device slot 149 adapted to receive the computing device 310. In some embodiments, the device slot 149 may comprise two or more slot portions 148a, 148b, etc. (also herein referred to individually or collectively as 148). Each slot portion 148 may be included in a corresponding device supporting panel 140. The slot portions 148a, 148b, etc., may be aligned and collectively retain and support the computing device 310. For example, as shown in FIG. 1, when set up, panel 140a may be situated in substantial parallel (e.g., within 5 or less degrees) of panel 140b, such that slot portion 148a may face slot portion 148b. Thus, the device slots 148 of the device supporting panels 140 may form a stand channel in which the computing device 310 may be situated and collectively supported by the device supporting panels 140. In some embodiments, when the computing device 310 is placed into the device slots 148 of the device supporting panels 140, an edge of the computing device 310 may rest against a bottom surface and/or a front surface of each device slot 148, while at least a portion of a back surface of the computing device 310 may rest against a back surface of each device slot 148 and at least a portion of the device edge of the computing device rests against one or more of a bottom surface of the device slot and a front surface of the device slot when the computing device is situated in the device slot. As a result, the computing device 310 may be positioned in the stand channel formed by the device slots 148 of the device supporting panels 140 at a leaning angle.

In some embodiments, the computing devices 310 may be classified into various device categories based on their device attributes (e.g., type of device, brand name, device model, device size, etc.), and each device category may be associated with a particular type of device supporting panel. For each device supporting panel 140, its type of device supporting panel may be indicated by a panel marker 149 positioned on the device supporting panel 140 and may be referred to herein as the panel type of the device supporting panel 140. In some embodiments, a first panel type corresponding to a first device category may have various panel dimensions (e.g., a height dimension of the back edge of the device slot 148, a distance between the bottom edge of the device slot 148 and a bottom edge of the device supporting panel 140, etc.) being based on the device size of the computing devices 310 in the first device category. Thus, when the device supporting panels 140 of the first panel type are coupled to the base platform 112 and a computing device 310 in the first device category is placed in their device slots 148, the stand assembly 100 may position the computing device 310 at a predefined leaning angle (e.g.,) 35°, and elevate the video capture device 320 of the computing device 310 to a predefined camera height relative to the physical activity surface on which the stand assembly 100 is situated (e.g., 30 cm). In some embodiments, the panel marker 149 of the device supporting panel 140 may be located within the field of view of the video capture device 320 of the computing device 310 when the computing device 310 is placed on the stand assembly 100, and thus the panel marker 149 may be captured by the video capture device 320.

In some embodiments, the panel slot 114 of the base platform 112 may be compatible with various panel types corresponding to various device categories (e.g., mobile phone, tablet, iPad Mini tablet, iPad Pro tablet, etc.). Thus, by selecting the device supporting panel 140 of the panel type corresponding to the device category of the computing device 310 and coupling the selected device supporting panel 140 to the panel slot 114, the stand assembly 100 may be adjusted to position various computing devices 310 at the same or similar predefined leaning angle and elevate their video capture device 320 to the same or similar camera height. Therefore, the video capture devices 320 of various computing devices 310 may have the same or similar field of view when the computing devices 310 are placed on the stand assembly 100. In addition, the base platform 112 may include multiple panel slots 114 with various distances between the panel slots 114. Thus, by selecting the panel slots 114 that have the distance between two outermost panel slots 114 satisfying the device size of the computing device 310 and coupling the device supporting panels 140 to the selected panel slots 114, the stand assembly 100 may be adjusted to position various computing devices 310 that have different device sizes.

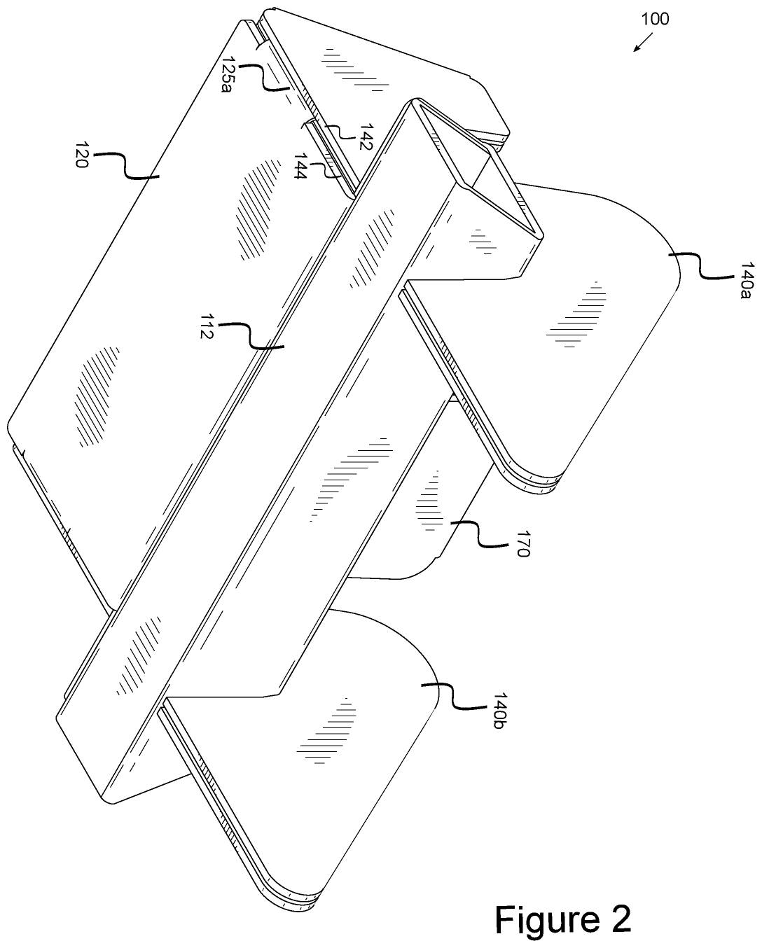

In some embodiments, the device supporting panel 140 may be detachably coupled to the front panel 120 of the base structure 110. As depicted in FIGS. 2 and 9, the device supporting panel 140 may wrap around a front panel tab 124 extending from the front panel 120, and the device supporting panel 140 may then be retained in the panel slot 114 of the base platform 112 with the front panel tab 124 situated inside the device supporting panel 140. As a result of this structure, the relative position between the front panel 120, the device supporting panel 140, and the base platform 112 can be maintained, and the stability of the stand assembly 100 can be improved.

In some embodiments, the stand assembly 100 may include a visual indicator 122 positioned on the front panel 120. In some embodiments, the visual indicator 122 may be located within the field of view of the video capture device 320 of the computing device 310 when the computing device 310 is placed on the stand assembly 100, and thus the visual indicator 122 may be captured by the video capture device 320. In some embodiments, the visual indicator 122 may indicate the stand attributes of the stand assembly 100 (e.g., stand type, stand dimensions, etc.) and/or the stand configuration of the stand assembly 100 (e.g., the panel slots 114 and the device supporting panels 140 being used to assemble the stand assembly 100, etc.). In some embodiments, the visual indicator 122 may be used as a reference point in processing the video stream to determine a relative position of a tangible object on the physical activity surface relative to the stand assembly 100, determine whether the stand components of the stand assembly 100 are correctly assembled, etc.

In some embodiments, the stand assembly 100 may include a slot 118 positioned on the base platform 112 as depicted in FIGS. 9 and 10. The slot 118 may be adapted to receive an adapter support 170 on which the camera adapter 330 may be placed. The adapter support may comprise a protrusion that may be received, retained by, and removed from the slot 118. In some embodiments, when the camera adapter 330 is placed on the adapter support 170, the adapter support 170 may be located within a slot of the camera adapter 330, and the camera adapter 330 may rest on the adapter support 170. The implementation of the adapter support 170 is advantageous, because it prevents the camera adapter 330 from being loose and potentially separated from other components of the display positioning system 300 (e.g., lost, etc.) when the camera adapter 330 is not in use.

In some embodiments, the user may construct the stand assembly 100 from the stand components and deconstruct the stand assembly 100 into the stand components as desired. In some embodiments, the product package of the display positioning system 300 may be provided to the user with the stand components of the stand assembly 100 in their complete shape. For example, each stand component may be provided in the product package as an individual item that is ready to use. Alternatively, the user may separate the stand components from one or more pieces of material on which the stand components are formed. For example, the stand components may be perforated on one or more cardboard sheets or plastic sheets in the product package, and the user may detach the stand components from the cardboard sheets or plastic sheets along their perforated line. In some embodiments, the stand components of the stand assembly 100 may be provided to the user in a generative format (e.g., a printable data file), and the user may create the stand components from available material accordingly. For example, the user may print the stand components on one or more paperboard sheets, and cut out of the paperboard sheets the stand components that are ready to use.

In some embodiments, the user may assemble the stand components into the stand assembly 100 based on a set of sequential assembling instructions. The assembling instructions may be provided in a separate instruction document (e.g., step-by-step instruction page, etc.) or on the same pieces of material from which the stand components are detached. In some embodiments, the assembling instructions may be printed or displayed on the individual pieces of the stand components to guide the user during assembly. In some embodiments, the assembling instructions may also be provided electronically as a content item that can be displayed on the computing device 310 (e.g., video, audio, webpage, textual document, etc.). In some embodiments, to take the stand assembly 100 apart, the user may perform the opposite of each assembling instruction in a reverse order of the set of sequential assembling instructions.

In some embodiments, the user may also assemble the camera adapter 330 in addition to assembling the stand assemblyl00. For example, the user may construct the camera adapter 330 from one or more adapter components to form a housing of the camera adapter 330, and position an optical element inside the housing of the camera adapter 330 at a predefined angle (e.g.,) 54°. In some embodiments, the optical element may be securely coupled to the housing of the camera adapter 330 using various coupling elements (e.g., adhesive pad, Velcro pad, magnetic fastener, latch element, etc.). In some embodiments, the user may collect or create the adapter components of the camera adapter 330 in a manner similar to the stand components of the stand assembly 100 as discussed above.

In some embodiments, once the stand assembly 100 is assembled and situated on the physical activity surface, the computing device 310 may be placed on the stand assembly 100 and the video capture device 320 of the computing device 310 may capture a video stream that includes the activity scene of the physical activity surface. In some embodiments, the computing device 310 may process the video stream captured by the video capture device 320, and determine whether a stand component of the stand assembly 100 is incorrectly assembled based on the relative position of the stand component relative to a reference point associated with the stand assembly 100 (e.g., other stand components, the visual indicator 122, the panel markers 149, etc.) and/or based on the component orientation of the stand component, etc. If the stand component of the stand assembly 100 is incorrectly assembled, the computing device 310 may determine an assembling instruction associated with the stand component from the set of sequential assembling instructions, and display the assembling instruction on the display screen of the computing device 310 for the user to reference and correct the stand component in the stand assembly 100.

In some embodiments, to process the video stream, the computing device 310 may detect in the video stream the visual indicator 122 and/or one or more panel markers 149 positioned on the stand assembly 100, and determine the stand attributes and the stand configuration of the stand assembly 100 based on the visual indicator 122 and/or the panel markers 149. For example, the computing device 310 may determine the stand dimensions of the stand assembly 100, the stand configuration of the stand assembly 100 (e.g., the panel slots 114 and the panel type of the device supporting panels 140 being used to assemble the stand assembly 100, etc.). In some embodiments, the computing device 310 may determine a calibration profile corresponding to the stand attributes and the stand configuration of the stand assembly 100, and use the calibration parameters in the calibration profile (e.g., distance parameter, tilt parameter, roll parameter, etc.) to process the video stream. In some embodiments, the computing device 310 may process the video stream using the calibration profile to detect tangible objects in the images of the video stream. The activity applications implemented in the computing device 310 may then use the tangible objects detected in the video stream to perform their operations. For example, the activity application may display a visualization of the tangible objects on the display screen of the computing device 310.

The stand assembly 100 and other components of the display positioning system 300 are described in further details below with reference to at least FIGS. 1-12C.

As discussed elsewhere herein, the user may assemble the stand assembly 100 and set up the display positioning system 300 on the physical activity surface to position the computing device 310. In some embodiments, the physical activity surface may be a physical surface on which the user may create a tangible work (e.g., drawings), manipulate and/or interact with various tangible objects (e.g., puzzle pieces, programming tiles, etc.), etc. The physical activity surface may be vertical, horizontal, or positioned at any angle suitable for the user to interact with the tangible objects. The physical activity surface may have any color, texture, pattern, and topography. For example, the physical activity surface may be substantially flat or disjointed/discontinuous in nature. Non-limiting examples of the physical activity surface include a table, a desk, a counter, a wall, a whiteboard, a chalkboard, a ground surface, a customized surface, etc. In some embodiments, the physical activity surface may include a medium on which the user may render works (e.g., paper, canvas, fabric, clay, foam, etc.).

In some embodiments, the physical activity surface may be preconfigured for certain activities. For example, the physical activity surface may include an activity scene (e.g., a drawing area). In some embodiments, the activity scene may be integrated with the stand assembly 100. Alternatively, the activity scene may be distinct from the stand assembly 100 but located adjacent to the stand assembly 100. In some embodiments, the activity scene may indicate to the user the portion of the physical activity surface that is within the field of view of the video capture device 320. In some embodiments, the size of the interactive area on the activity scene may be bounded by the field of view of the video capture device 320 and may be adapted by the camera adapter 330 and/or by assembling the stand assembly 100 with the stand configuration corresponding to the computing device 310 to adjust the position of the video capture device 320. In some embodiments, the activity scene may be a light projection (e.g., pattern, context, shapes, etc.) projected onto the physical activity surface.

In some embodiments, the stand assembly 100 may be situated on the physical activity surface or located proximate to the physical activity surface, and the computing device 310 may be placed on the stand assembly 100. The computing device 310 may include activity applications capable of providing the user with a virtual scene that is responsive to the tangible objects and/or the user interactions with the tangible objects on the physical activity surface in real-time. In some embodiments, the computing device 310 may be placed on the stand assembly 100 situated in front of the user so that the user can conveniently see the display screen of the computing device 310 while interacting with the tangible objects on the physical activity surface. Non-limiting examples of the computing device 310 include mobile phones (e.g., feature phones, smart phones, etc.), tablets, laptops, desktops, netbooks, TVs, set-top boxes, media streaming devices, portable media players, navigation devices, personal digital assistants, etc.

As discussed elsewhere herein, the computing device 310 may include the video capture device 320 (also referred to herein as a camera) for capturing a video stream of the physical activity surface. Alternatively, the video capture device 320 may be an independent unit distinct from the computing device 310 and coupled to the computing device 310 via a wired or wireless connection to provide the computing device 310 with the video stream being captured. In some embodiments, the video capture device 320 may be a front-facing camera or a rear-facing camera of the computing device 310. For example, as depicted in FIGS. 3A and 3B, the video capture device 320 may be a front-facing camera being equipped with the camera adapter 330 that adapts the field of view of the video capture device 320 to include at least a portion of the physical activity surface. The activity scene of the physical activity surface that is captured by the video capture device 320 may also be referred to herein as the activity surface.

As depicted in FIG. 3, the computing device 310 and/or the video capture device 320 may be positioned and/or supported by the stand assembly 100. In some embodiments, the stand assembly 100 may be assembled based on a stand configuration corresponding to the computing device 310, thereby positioning the video capture device 320 of the computing device 310 at a predefined position that is optimal to accurately capture the objects in the activity scene of the physical activity surface. The position of the video capture device 320 relative to the physical activity surface may be referred to herein as the camera position or the capture position of the video capture device 320. In some embodiments, as the computing device 310 is placed on the stand assembly 100, the display screen of the computing device 310 may be in a position that facilitates the user in viewing and interacting with the content on the display screen while the user is simultaneously interacting with the physical environment (e.g., the activity scene of the physical activity surface). In some embodiments, the stand assembly 100 may be constructed to situate on the physical activity surface, receive and sturdily hold the computing device 310 so that the computing device 310 remains still during use.

In some embodiments, the camera adapter 330 (also referred to herein as an adapter) may be positioned on the computing device to adapt the video capture device 320 of the computing device 310 to capture a field of view that includes at least a portion of the activity scene of the physical activity surface, although other implementations are also possible and contemplated. As an example, the video capture device 320 may be the front-facing camera and the camera adapter 330 may split the field of view of the front-facing camera into multiple scenes. In this example, the video capture device 320 may capture the activity scene that includes multiple portions of the physical activity surface, and determine tangible objects and/or works created by a user in any portion of the activity scene. In another example, the camera adapter 330 may redirect a rear-facing camera of the computing device 310 toward the front-side of the computing device 310 to capture the activity scene of the physical activity surface that is located in front of the computing device 310. In some embodiments, the camera adapter 330 may define one or more sides of the scene being captured (e.g., top, left, right, with bottom open, etc.).

In some embodiments, the camera adapter 330 may include a slot 336 adapted to receive an edge of the computing device 310 and retain (e.g., secure, grip, etc.) the camera adapter 330 on the edge of the computing device 310. In some embodiments, the camera adapter 330 may be positioned over the video capture device 320 to direct the field of view of the video capture device 320 toward the physical activity surface. As depicted in FIG. 1, the stand assembly 100 may include the adapter support 170 configured to receive and retain the camera adapter 330 when the camera adapter 330 is not in use.

In some embodiments, the camera adapter 330 may include one or more optical elements, such as mirrors and/or lenses, to adapt the standard field of view of the video capture device 320. To adapt the field of view of the video capture device 320, the mirrors and/or lenses of the camera adapter 330 may be positioned at an angle to redirect and/or modify the light being reflected from physical activity surface into the video capture device 320. As an example, the camera adapter 330 may include a mirror 334 being angled to redirect the light reflected from the physical activity surface in front of the computing device 310 into a front-facing camera of the computing device 310. In another example, the computing device 310 may include a front-facing camera having a fixed line of sight relative to the display screen of the computing device 310. The camera adapter 330 may be detachably connected to the computing device 310 over the video capture device 320 to augment the line of sight of the video capture device 320 so that the video capture device 320 can capture the physical activity surface (e.g., surface of a table).

An example camera adapter 330 is depicted in FIG. 3. As illustrated, the camera adapter 330 may include a housing 332, a slot 336, and a mirror 334 being positioned at a mirror angle relative to the edge 338 of the slot 336 (e.g., 54° (±5°). In some embodiments, the mirror angle may be specific to the video capture device 320, and thus the computing devices 310 having different video capture devices 320 and/or different camera configurations of the video capture device 320 may need to be used with different camera adapters 330 having different mirror angles. In some embodiments, the mirror 334 of the camera adapter 330 may be adjustable to be positioned at various mirror angles, and thus the camera adapter 330 can be used with various computing devices 310. A range of mirror angles are also possible and contemplated.

In some embodiments, the mirrors and/or lenses of the camera adapter 330 may be laser quality glass or may be polished. In some embodiments, the mirrors and/or lenses may include a first surface that is a reflective element. The first surface may be a coating/thin film capable of redirecting light without having to pass through the glass of a mirror and/or lens. Alternatively, a first surface of the mirrors and/or lenses may be a coating/thin film and a second surface may be a reflective element. In these embodiments, the light may pass through the coating twice. However, since the coating is extremely thin relative to the glass, the distortion effect may be reduced as compared to a conventional mirror. This implementation is advantageous, because it can reduce the distortion effect of a conventional mirror in a cost-effective way.

In some embodiments, the camera adapter 330 may include a series of optical elements (e.g., mirrors 334) that wrap the light reflected off of the physical activity surface located in front of the computing device 310 into a rear-facing camera of the computing device 310 so that it can be captured. In some embodiments, the camera adapter 330 may adapt a portion of the field of view of the video capture device 320 (e.g., the front-facing camera) and leave a remaining portion of the field of view unaltered so that the video capture device 320 may capture multiple scenes. In some embodiments, the camera adapter 330 may also include optical element(s) that are configured to provide different effects, such as enabling the video capture device 320 to capture a larger portion of the physical activity surface. For example, the camera adapter 330 may include a convex mirror that provides a fisheye effect to capture a larger portion of the physical activity surface than would otherwise be capturable by a standard configuration of the video capture device 320.

In some embodiments, the user may construct the camera adapter 330 from the adapter components. For example, the user may collect and/or create the adapter components from one or more pieces of material as discussed elsewhere herein, and assemble the adapter components together to form the housing 332 that includes the slot 336. The user may then couple the mirror 334 to the housing 332 at a predefined mirror angle. For example, the housing 332 assembled from the adapter components may include a surface located at the predefined mirror angle relative to the edge 338 of the slot 336, and the user may attach the mirror 334 to that surface using one or more coupling elements (e.g., adhesive pad, Velcro pad, engaging tab, latch element, snap fastener, etc.). In some embodiments, the mirror 334 may be provided to the user as part of the product package of the display positioning system 300. Alternatively, the user may use any available mirror that can fit into the designated position of the mirror within the housing 332 to be the mirror 334 of the camera adapter 330.

In some embodiments, the video capture device 320 may be configured to include at least a portion of the stand assembly 100 within its field of view. For example, the field of view of the video capture device 320 may include a portion of the front panel 120 that has the visual indicator 122 and/or a portion of the device supporting panel 140 that has the panel marker 149. In some embodiments, the portion of the stand assembly 100 may be considered a reference point to perform geometric/image calibration of the video capture device 320 and/or to determine whether the stand assembly 100 is incorrectly assembled. For example, the computing device 310 may determine the stand configuration of the stand assembly 100 based on the reference point, and calibrate the video capture device 320 (e.g., adjust the white balance, focus, exposure, etc.) using a calibration profile corresponding to the stand configuration of the stand assembly 100. The computing device 310 may also determine whether the stand assembly 100 is incorrectly assembled based on the position of one or more stand components of the stand assembly 100 relative to the reference point. If a stand component of the stand assembly 100 is incorrectly assembled, the computing device 310 may display one or more assembling instructions associated with the stand component for the user to reference and correct the stand component in the stand assembly 100.

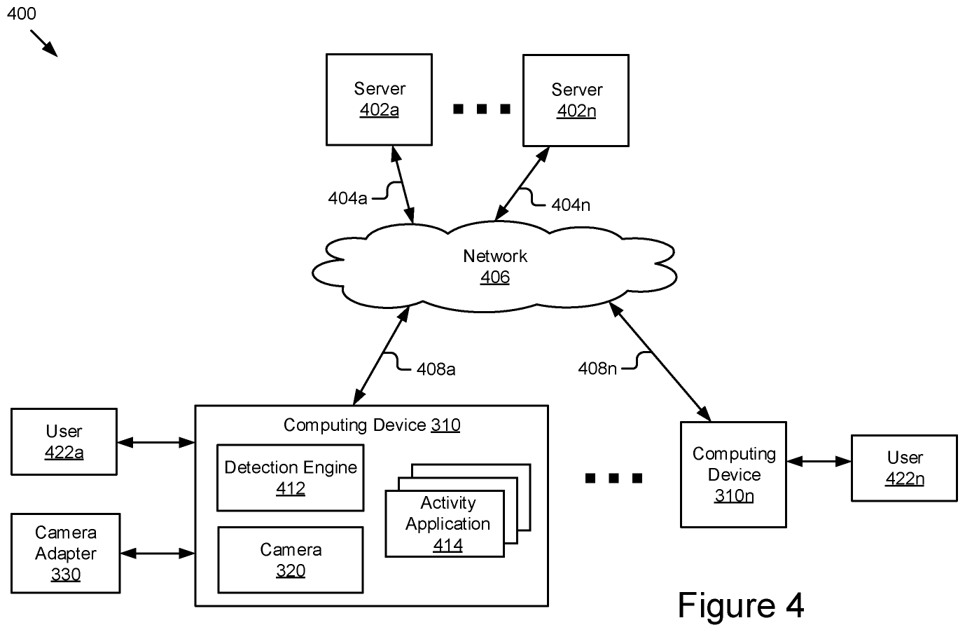

FIG. 4 is a block diagram illustrating an example computer system 400 that is used with the display positioning system 300. As depicted, the system 400 may include computing devices 310a . . . 310n and servers 402a . . . 402n communicatively coupled via a network 406. In FIG. 4 and the remaining figures, a letter after a reference number, e.g., “310a”, represents a reference to the element having that particular reference number. A reference number in the text without a following letter, e.g., “310”, represents a general reference to instances of the element bearing that reference number. It should be understood that the system 400 depicted in FIG. 4 is provided by way of example and that the system 400 and/or further systems contemplated by this present disclosure may include additional and/or fewer components, may combine components and/or divide one or more of the components into additional components, etc. For example, the system 400 may include any number of servers 402, computing devices 310, or networks 406. As depicted in FIG. 4, the computing device 310 may be coupled to the network 406 via the signal line 408 and the server 402 may be coupled to the network 406 via the signal line 404. The computing device 310 may be accessed by a user 422. The user 422 may be referred to herein as the user.

The network 406 may include any number of networks and/or network types. For example, the network 406 may include, but is not limited to, one or more local area networks (LANs), wide area networks (WANs) (e.g., the Internet), virtual private networks (VPNs), mobile (cellular) networks, wireless wide area network (WWANs), WiMAX® networks, Bluetooth® communication networks, peer-to-peer networks, other interconnected data paths across which multiple devices may communicate, various combinations thereof, etc.

The computing device 310 may be a computing device that has data processing and communication capabilities. In some embodiments, the computing device 310 may include a processor (e.g., virtual, physical, etc.), a memory, a power source, a network interface, and/or other software and/or hardware components, such as front and/or rear facing cameras, display screen, graphics processor, wireless transceivers, keyboard, firmware, operating systems, drivers, various physical connection interfaces (e.g., USB, HDMI, etc.). In some embodiments, the computing device 310 may be coupled to and communicate with one another and with other entities of the system 400 via the network 406 using a wireless and/or wired connection. As discussed elsewhere herein, the system 400 may include any number of computing devices 310 and the computing devices 310 may be the same or different types of devices (e.g., tablets, mobile phones, desktop computers, laptop computers, etc.).

As depicted in FIG. 4, the computing device 310 may include the video capture device 320 (e.g., the camera 320), a detection engine 412, and one or more activity applications 414. The computing device 310 and/or the video capture device 320 may be equipped with the camera adapter 330 as discussed elsewhere herein. In some embodiments, the detection engine 412 may detect and/or recognize tangible objects located in the activity scene of the physical activity surface, and cooperate with the activity application(s) 414 to provide the user 422 with a virtual experience that incorporates in real-time the tangible objects and the user manipulation of the tangible objects in the physical environment. In some embodiments, the user may create tangible objects on the activity scene (e.g., drawings) and/or organize or manipulate existing tangible objects on the activity scene (e.g., puzzle pieces, programming tiles, etc.). In some embodiments, the tangible objects may be made from one or more inexpensive materials (e.g., cardboard, paperboard, low-cost plastic, etc.) and may be provided to the user as part of the product package of the display positioning system 300.

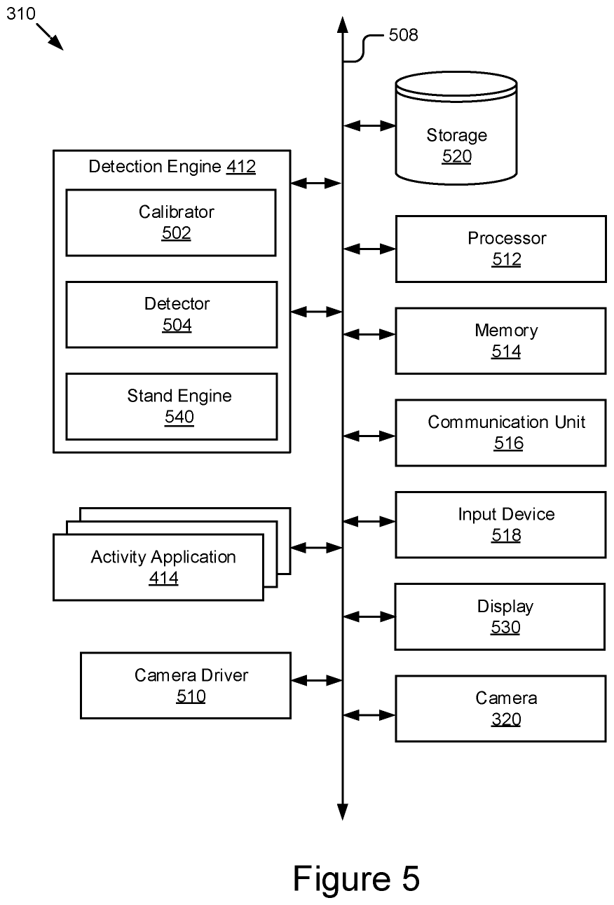

As an example of the cooperative operations performed by the detection engine 412 and the activity applications 414, the detection engine 412 may process the video stream captured by the video capture device 320 to detect and recognize a tangible object created by the user on the activity scene. The activity application 414 may generate a visualization of the tangible object created by the user, and display to the user a virtual scene in which an animated character may interact with the visualization of the tangible object. In another example, the detection engine 412 may process the video stream captured by the video capture device 320 to detect and recognize a sequence of programming tiles organized by the user on the activity scene. The activity application 414 may determine a series of commands represented by the sequence of programming tiles and execute these commands in order, thereby causing a virtual object to perform corresponding actions in a virtual environment being displayed to the user. The components and operations of the detection engine 412 and the activity application 414 are described in details below with reference to at least FIGS. 5-7.

The server 402 may include one or more computing devices that have data processing, storing, and communication capabilities. In some embodiments, the server 402 may include one or more hardware servers, server arrays, storage devices and/or storage systems, etc. In some embodiments, the server 402 may be a centralized, distributed and/or a cloud-based server. In some embodiments, the server 402 may include one or more virtual servers that operate in a host server environment and access the physical hardware of the host server (e.g., processor, memory, storage, network interfaces, etc.) via an abstraction layer (e.g., a virtual machine manager).

The server 402 may include software applications operable by one or more processors of the server 402 to provide various computing functionalities, services, and/or resources, and to send and receive data to and from the computing devices 310. For example, the software applications may provide the functionalities of internet searching, social networking, web-based email, blogging, micro-blogging, photo management, video/music/multimedia hosting/sharing/distribution, business services, news and media distribution, user account management, or any combination thereof. It should be understood that the server 402 may also provide other network-accessible services.

In some embodiments, the server 402 may include a search engine capable of retrieving results that match one or more search criteria from a data store. As an example, the search criteria may include an image and the search engine may compare the image to product images in its data store (not shown) to identify a product that matches the image. In another example, the detection engine 412 and/or the storage 520 (e.g., see FIG. 5) may request the search engine to provide information that matches a physical drawing, an image, and/or a tangible object extracted from a video stream.

It should be understood that the system 400 illustrated in FIG. 4 is provided by way of example, and that a variety of different system environments and configurations are contemplated and are within the scope of the present disclosure. For example, various functionalities may be moved from a server to a client, or vice versa and some implementations may include additional or fewer computing devices, services, and/or networks, and may implement various client or server-side functionalities. In addition, various entities of the system 400 may be integrated into a single computing device or system or divided into additional computing devices or systems, etc.

FIG. 5 is a block diagram of an example computing device 310. As depicted, the computing device 310 may include a processor 512, a memory 514, a communication unit 516, a display 530, the video capture device 320 (the camera 320), and an input device 518 communicatively coupled by a bus 508. It should be understood that the computing device 310 is not limited to such and may include other components, including, for example, those discussed with reference to the computing devices 310 in FIGS. 3A, 3B, and 4.

The processor 512 may execute software instructions by performing various input/output, logical, and/or mathematical operations. The processor 512 may have various computing architectures to process data signals including, for example, a complex instruction set computer (CISC) architecture, a reduced instruction set computer (RISC) architecture, and/or an architecture implementing a combination of instruction sets. The processor 512 may be physical and/or virtual, and may include a single core or plurality of processing units and/or cores.

The memory 514 may be a non-transitory computer-readable medium that is configured to store and provide access to data to other components of the computing device 310. In some embodiments, the memory 514 may store instructions and/or data that are executable by the processor 512. For example, the memory 514 may store the detection engine 412, the activity applications 414, and the camera driver 510. The memory 514 may also store other instructions and data, including, for example, an operating system, hardware drivers, other software applications, data, etc. The memory 514 may be coupled to the bus 508 for communication with the processor 512 and other components of the computing device 310.

The communication unit 516 may include one or more interface devices (I/F) for wired and/or wireless connectivity with the network 406 and/or other devices. In some embodiments, the communication unit 516 may include transceivers for sending and receiving wireless signals. For example, the communication unit 516 may include radio transceivers for communication with the network 406 and for communication with nearby devices using close-proximity connectivity (e.g., Bluetooth®, Near-Field Communication (NFC), etc.). In some embodiments, the communication unit 516 may include ports for wired connectivity with other devices. For example, the communication unit 516 may include a CAT-5 interface, Thunderbolt™ interface, FireWire™ interface, Universal Serial Bus (USB) interface, etc.

The display 530 may display electronic images and data output by the computing device 310 for presentation to the user 422. The display 530 may include any display device, monitor or screen, including, for example, an organic light-emitting diode (OLED) display, a liquid crystal display (LCD), etc. In some embodiments, the display 530 may be a touch-screen display capable of receiving input from one or more fingers of the user 422. For example, the display 530 may be a capacitive touch-screen display capable of detecting and interpreting multiple points of contact with the display surface. In some embodiments, the computing device 310 may include a graphic adapter (not shown) for rendering and outputting the images and data for presentation on display 530. The graphic adapter may be a separate processing device including a separate processor and memory (not shown) or may be integrated with the processor 512 and the memory 514.

The input device 518 may include any device for inputting information into the computing device 310. In some embodiments, the input device 518 may include one or more peripheral devices. For example, the input device 518 may include a keyboard (e.g., a QWERTY keyboard), a pointing device (e.g., a mouse or touchpad), a microphone, a camera, etc. In some implementations, the input device 518 may include a touch-screen display capable of receiving input from the one or more fingers of the user 422. In some embodiments, the functionality of the input device 518 and the display 530 may be integrated, and the user 422 may interact with the computing device 310 by contacting a surface of the display 530 using one or more fingers. For example, the user 422 may interact with an emulated keyboard (e.g., soft keyboard or virtual keyboard) displayed on the touch-screen display 530 by contacting the display 530 in the keyboard regions using his or her fingers.

The detection engine 412 may include a calibrator 502, a detector 504, and a stand engine 540. The components 412, 502, 504, and 540 may be communicatively coupled to one another and/or to other components 414, 510, 520, 530, 512, 514, 516, 518, and/or 320 of the computing device 310 by the bus 508 and/or the processor 512. In some embodiments, the components 412, 502, 504, and 540 may be sets of instructions executable by the processor 512 to provide their functionality. In some embodiments, the components 412, 502, 504, and 540 may be stored in the memory 514 of the computing device 310 and may be accessible and executable by the processor 512 to provide their functionality. In any of the foregoing implementations, these components 412, 502, 504, and 540 may be adapted for cooperation and communication with the processor 512 and other components of the computing device 310.

The calibrator 502 includes software and/or logic for performing image calibration and/or geometric calibration on the video stream captured by the video capture device 320. In some embodiments, to perform the image calibration, the calibrator 502 may calibrate the images in the video stream to adapt to the capture position of the video capture device 320, which may be dependent on the stand configuration of the stand assembly 100 on which the computing device 310 is situated. As discussed elsewhere herein, the stand assembly 100 may be set up with a stand configuration in which the device supporting panels 140 corresponding to the computing device 310 may be inserted into the panel slots 114 that satisfy the device size of the computing device 310, and the stand assembly 100 may then be situated on the physical activity surface. Thus, when the computing device 310 is placed on the stand assembly 100, the stand assembly 100 may position the video capture device 320 of the computing device 310 at a camera height relative to the physical activity surface and a tilt angle relative to a horizontal line. Capturing the video stream from this camera position may cause distortion effects on the video stream. Therefore, the calibrator 502 may adjust one or more operation parameters of the video capture device 320 to compensate for these distortion effects. Examples of the operation parameters being adjusted include, but are not limited to, focus, exposure, white balance, aperture, f-stop, image compression, ISO, depth of field, noise reduction, focal length, etc. Performing image calibration on the video stream is advantageous, because it can optimize the images of the video stream to accurately detect the objects depicted therein, and thus the operations of the activity applications 414 based on the objects detected in the video stream can be significantly improved.

In some embodiments, the calibrator 502 may also calibrate the images to compensate for the characteristics of the activity surface (e.g., size, angle, topography, etc.). For example, the calibrator 502 may perform the geometric calibration to account for the discontinuities and/or the non-uniformities of the activity surface, thereby enabling accurate detection of objects on the activity surface when the stand assembly 100 and the computing device 310 are set up on various activity surfaces (e.g., bumpy surface, beds, tables, whiteboards, etc.). In some embodiments, the calibrator 502 may calibrate the images to compensate for optical effect caused by the camera adapter 330 and/or the optical elements of the video capture device 320. In some embodiments, the calibrator 502 may also calibrate the video capture device 320 to split its field of view into multiple portions with the user being included in one portion of the field of view and the activity surface being included in another portion of the field of view of the video capture device 320.

In some embodiments, different types of computing device 310 may use different types of video capture device 320 that have different camera specifications. For example, the tablets made by Apple may use a different type of video capture device 320 from the tablets made by Amazon. In some embodiments, the calibrator 502 may use the camera information specific to the video capture device 320 of the computing device 310 to calibrate the video stream captured by the video capture device 320 (e.g., focal length, distance between the video capture device 320 to the bottom edge of the computing device 310, etc.). As discussed elsewhere herein, the calibrator 502 may also use the camera position at which the video capture device 320 is located to perform the image calibration and/or the geometric calibration. In some embodiments, the calibrator 502 may determine the camera position of the video capture device 320 based on the visual indicator 122 positioned on the front panel 120 and/or the panel markers 149 positioned on the device supporting panels 140 of the stand assembly 100.

The stand engine 540 includes software and/or logic for determining whether the stand assembly 100 is incorrectly assembled and providing assembling instructions for the user accordingly. In some embodiments, the stand engine 540 may determine the component orientation of the stand components of the stand assembly 100 and/or determine the relative position of the stand components of the stand assembly 100 relative to a reference point associated with the stand assembly 100 (e.g., the visual indicator 122, the panel marker 149, other stand components of the stand assembly 100, etc.), and determine a stand component that is incorrectly assembled in the stand assembly 100. In some embodiments, the stand engine 540 may compare the stand assembly 100 to the assembling model of the stand assembly 100, and determine a stand component that is incorrectly assembled in the stand assembly 100. The stand engine 540 may then determine one or more assembling instructions corresponding to the stand component that is incorrectly assembled, and display the assembling instructions to the user on the display 530 of the computing device 310. The user may reference the assembling instructions, and correct the stand component in the stand assembly 100.

The detector 504 includes software and/or logic for processing the video stream captured by the video capture device 320 to detect the tangible objects present on the activity surface as well as the visual indicator 122, the panel marker 149, the device supporting panels 140, and/or other stand components of the stand assembly 100 in the video stream. In some embodiments, to detect an object in the video stream, the detector 504 may analyze the images of the video stream to determine line segments, and determine the object that has the contour matching the line segments using the object data in the storage 520. In some embodiments, the detector 504 may provide the tangible objects detected in the video stream to the activity applications 414, and provide the stand components of the stand assembly 100 (e.g., the visual indicator 122, the panel marker 149, the device supporting panels 140, etc.) detected in the video stream to the calibrator 502 and the stand engine 540. In some embodiments, the detector 504 may store the tangible objects and the stand components of the stand assembly 100 detected in the video stream in the storage 520 for retrieval by these processing components. In some embodiments, the detector 504 may determine whether the line segments and/or the object associated with the line segments can be identified in the video stream, and instruct the calibrator 502 to calibrate the images of the video stream accordingly.

The activity application 414 includes software and/or logic executable on the computing device 310. In some embodiments, the activity application 414 may receive the tangible objects detected in the video stream of the activity surface from the detector 504. In some embodiments, the activity application 414 may generate a virtual environment that incorporates, in real-time, the virtualization of the tangible objects and the user manipulation of the tangible objects on the activity surface, and display the virtual environment to the user on the computing device 310. Non-limiting examples of the activity application 414 include video games, learning applications, assistive applications, storyboard applications, collaborative applications, productivity applications, etc. Other types of activity application are also possible and contemplated.

The camera driver 510 includes software storable in the memory 514 and operable by the processor 512 to control/operate the video capture device 320. For example, the camera driver 510 may be a software driver executable by the processor 512 for instructing the video capture device 320 to capture and provide a video stream and/or a still image, etc. In some embodiments, the camera driver 510 may be capable of controlling various features of the video capture device 320 (e.g., flash, aperture, exposure, focal length, etc.). In some embodiments, the camera driver 510 may be communicatively coupled to the video capture device 320 and other components of the computing device 310 via the bus 508, and these components may interface with the camera driver 510 to capture videos and/or still images using the video capture device 320.

As discussed elsewhere herein, the video capture device 320 is a video capture device (e.g., a camera) adapted to capture video streams and/or images of the physical activity surface. In some embodiments, the video capture device 320 may be coupled to the bus 508 for communication and interaction with the other components of the computing device 310. In some embodiments, the video capture device 320 may include a lens for gathering and focusing light, a photo sensor including pixel regions for capturing the focused light, and a processor for generating image data based on signals provided by the pixel regions. The photo sensor may be any type of photo sensor (e.g., a charge-coupled device (CCD), a complementary metal-oxide-semiconductor (CMOS) sensor, a hybrid CCD/CMOS device, etc.). In some embodiments, the video capture device 320 may include a microphone for capturing sound. Alternatively, the video capture device 320 may be coupled to a microphone that is coupled to the bus 508 or included in another component of the computing device 310. In some embodiments, the video capture device 320 may also include a flash, a zoom lens, and/or other features. In some embodiments, the processor of the video capture device 320 may store video and/or still image data in the memory 514 and/or provide the video and/or still image data to other components of the computing device 310, such as the detection engine 412 and/or the activity applications 414.

The storage 520 is a non-transitory storage medium that stores and provides access to various types of data. Non-limiting examples of the data stored in the storage 520 include video stream and/or still images captured by the video capture device 320, object data describing various tangible objects, visual indicators, and/or panel markers (e.g., object contour, color, shape and size, etc.), object detection result indicating the tangible objects, the visual indicator 122, the panel markers 149 detected in the video stream and/or still images, etc. In some embodiments, the data stored in the storage 520 may also include one or more calibration profiles, each calibration profile may be associated with a camera position of the video capture device 320 relative to the physical activity surface and include calibration parameters for calibrating the video stream and/or still images captured by the video capture device 320 at the camera position. In some embodiments, the calibration profile may be associated with a stand configuration of the stand assembly 100 (e.g., the panel slots 114 and the device supporting panels 140 being used to assemble the stand assembly 100, etc.) on which the camera position of the video capture device 320 is dependent. Non-limiting examples of the calibration parameters in the calibration profile include a distance parameter indicating the distance between the video capture device 320 and the physical activity surface, the tilt parameter indicating the tilt angle of the video capture device 320 relative to the horizontal line, etc. Other calibration parameters are also possible and contemplated.

In some embodiments, the storage 520 may be included in the memory 514 or another storage device coupled to the bus 508. In some embodiments, the storage 520 may be or included in a distributed data store, such as a cloud-based computing and/or data storage system. In some embodiments, the storage 520 may include a database management system (DBMS). The DBMS may be a structured query language (SQL) DBMS. For example, the storage 520 may store data in an object-based data store or multi-dimensional tables including rows and columns, and may manipulate (i.e., insert, query, update, and/or delete) data entries stored in the storage 520 using programmatic operations (e.g., SQL queries and statements or a similar database manipulation library). Other implementations of the storage 520 with additional characteristics, structures, acts, and functionalities are also possible and contemplated.

As discussed elsewhere herein, the display positioning system 300 may include the stand assembly 100. The stand assembly 100 may be constructed from multiple stand components detachably assembled to one another and may be deconstructed back into multiple stand components as desired. In some embodiments, the stand assembly 100 may be assembled and situated on the physical activity surface and may receive the computing device 310 in the stand channel formed by the device slots 148 of its device supporting panels 140. When the computing device 310 is placed in this stand channel, the stand assembly 100 may situate the computing device 310 in a position at which the video capture device 320 of the computing device 310 is located at a predefined camera position relative to the physical activity surface to capture the video stream of the activity scene on the physical activity surface. As discussed elsewhere herein, the stand assembly 100 may be constructed using the device supporting panels 140 and the panel slots 114 that correspond to the computing device 310 being situated on the stand assembly 100. By adaptively assembling the stand assembly 100 based on the computing device 310, the camera position of the video capture device 320 (e.g., camera height, tilt angle, etc.) when the computing device 310 is placed on the stand assembly 100 may be flexibly adjusted, and thus the stand assembly 100 can be used to receive and support different computing devices 310.

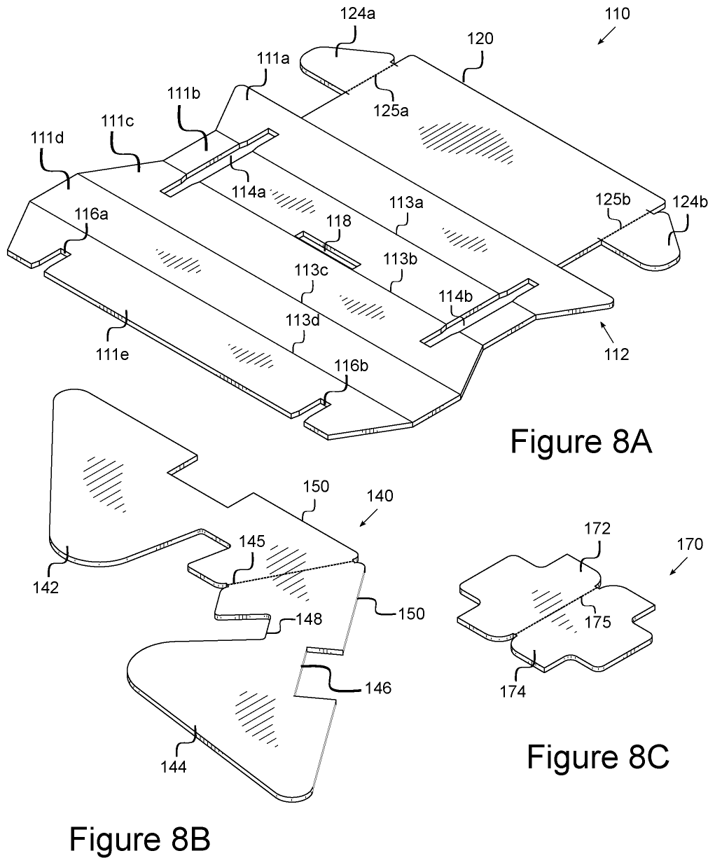

FIGS. 1 and 2 illustrate the perspective views of the stand assembly 100 in the assembled state. As depicted, the stand assembly 100 may include the base structure 110, the device supporting panels 140, and the adapter support protrusion 170170 being detachably coupled to one another. The base structure 110, the device supporting panel 140, and the adapter support 170 may in turn be constructed from their disassembled state that includes one or more component portions. The base structure 110, the device supporting panel 140, and the adapter support 170 in their disassembled state are depicted in FIGS. 8A-8C.

In some embodiments, the base structure 110 may include one or more base component that are detachably assembleable to form the base structure 110. The base structure 110 in its assembled state is depicted in FIGS. 9 and 10, and the base structure 110 in its disassembled state is depicted in FIG. 8A. As depicted in FIGS. 9 and 10, the base structure 110 may include the base platform 112, the front panel 120 extending from the base platform 112, and one or more front panel tabs 124 extending from the front panel 120. In some embodiments, the base platform 112 may connect to the front panel 120 and the front panel 120 may connect to the front panel tabs 124 so that the base structure 110 in its disassembled state may include these foldable base components connected as one item as depicted in FIG. 8A. Alternatively, the base platform 112 may be detachably coupleable to the front panel 120 and the front panel 120 may be detachably coupleable to the front panel tabs 124 using one or more coupling elements. Non-limiting examples of the coupling element include engaging tab, interlocking fastener, snap fastener, magnetic fastener, latch element, etc.

In some embodiments, the base platform 112 may include a plurality of platform portions 111 in which at least a first platform portion 111 may be detachably coupleable to a second platform portion 111 to form the base platform 112 from the plurality of platform portions 111. As an example, the base platform 112 may include the platform portion 111a, 111b, 111c, 111d, 111e and the front panel 120 may extend from the platform portion 111a as depicted in FIG. 8A. To assemble the base structure 110, the user may fold the platform portions 111 at the folding edge 113a of the platform portion 111a, the folding edge 113b of the platform portion 111b, the folding edge 113c of the platform portion 111c, and the folding edge 113d of the platform portion 111d so that the platform portions 111a, 111b, 111c, 111d, 111e may form the base platform 112 in the assembled state. As depicted in FIG. 9, the base platform 112 in the assembled state may have an elongated shape extended along a horizontal axis, and the device supporting panels 140 may be coupled to the base platform 112 along the base platform 112.

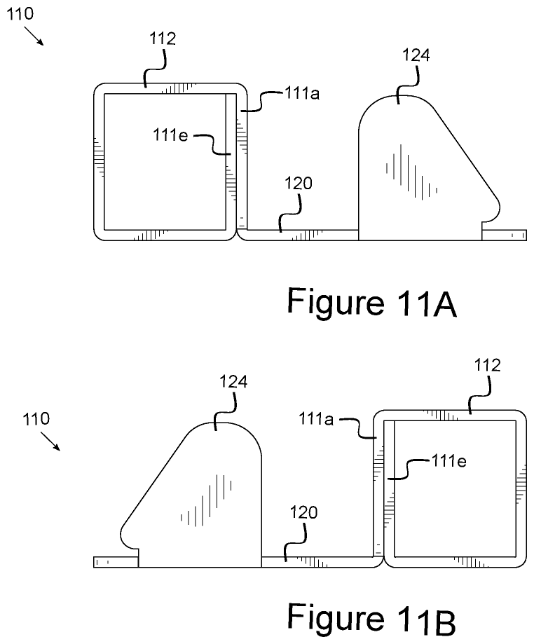

FIGS. 11A and 11B illustrate the side view of the base structure 110 in its assembled state from different perspectives. As depicted in FIGS. 11A and 11B, the base platform 112 constructed from the platform portions 111a, 111b, 111c, 111d, 111e may have a rectangular shape with the platform portion 111a and the platform portion 111e detachably coupleable to one another. As depicted, the platform portion 111a and the platform portion 111e may overlap and rest against one another to improve the stability of the base platform 112. In some embodiments, to maintain the shape of the base platform 112 in the assembled state, the platform portion 111a and the platform portion 111e may be coupled to one another using one or more coupling elements (e.g., adhesive tab, Velcro tab, snap fastener, magnetic fastener, latch element, etc.). Alternatively, the base platform 112 may be inserted into the base slot 146 of the device supporting panel 140, and the base slot 146 may be compatible with the base platform 112. Therefore, the base slot 146 may retain the relative positions of the platform portions 111 that form the base platform 112, thereby maintaining the base platform 112 in its assembled state. It should be understood that the base platform 112 may include any number of platform portions 111, and the platform portions 111 may be assembled together to form the base platform 112 in any geometric shape (e.g., circular shape, triangular shape, multi-sided shape, etc.). In some embodiments, instead of folding the platform portions 111 that are connected to form the base platform 112, the user may assemble multiple individual platform portions 111 together to form the base platform 112 using one or more coupling elements (e.g., engaging tab, snap fastener, magnetic fastener, latch element, etc.). Other implementations for constructing the base platform 112 from the platform portions 111 are also possible and contemplated.

As depicted in FIG. 8A, the base platform 112 may include one or more panel slots 114 adapted to receive one or more device supporting panels 140. In some embodiments, the panel slot 114 may extend across multiple platform portions 111, and thus when these platform portions 111 are folded relative to one another to form the base platform 112 in the assembled state, the panel slot 114 can receive the device supporting panel 140 therein as depicted in FIGS. 9 and 10. In some embodiments, the width dimension of the panel slot 114 may be adapted based on the device supporting panel 140 so that the device supporting panel 140 may compatibly fit into the panel slot 114 when the base platform 112 is in the assembled state. As a result, the panel slot 114 may grip the device supporting panel 140 to securely retain the device supporting panel 140 within the panel slot 114 due to the friction between the panel slot 114 and the device supporting panel 140, while still enabling the device supporting panel 140 to be easily removed from the panel slot 114 as needed.

In some embodiments, the platform portion 111e may include one or more gripping slots 116 that are aligned with the one or more panel slots 114 as depicted in FIG. 8A. Thus, when the platform portion 111a and the platform portion 111e are detachably coupled to one another to form the base platform 112 in the assembled state as depicted in FIG. 9, both the panel slot 114 and the gripping slot 116 that is aligned with the panel slot 114 may receive the device supporting panel 140 at the same time. As a result, the gripping slot 116 may provide additional grip to securely retain the device supporting panel 140 in the panel slot 114. In addition, the compatible insertion of the device supporting panel 140 into both the panel slot 114 included in the platform portion 111a and the gripping slot 116 included in the platform portion 111e may maintain the position of the platform portion 111a and the platform portion 111e that overlay and rest against one another, thereby maintaining the shape of the base platform 112 in the assembled state without using coupling elements between the platform portion 111a and the platform portion 111e.

In some embodiments, the length dimension of the panel slot 114 may be adapted based on the device supporting panel 140 so that when the base platform 112 is in the assembled state and the device supporting panel 140 is inserted into the panel slot 114, the panel slot 114 may have the depth dimension sufficient to securely retain the device supporting panel 140 in the panel slot 114 and the bottom edge 150 of the device supporting panel 140 may rest on the physical activity surface on which the stand assembly 100 is situated.

In some embodiments, the base platform 112 may include multiple panel slots 114, and the user may select two or more panel slots 114 from the multiple panel slots 114 to insert the device supporting panels 140 on which the computing device 310 is situated. In some embodiments, the user may select two panel slots 114 that have the distance between the two panel slots 114 satisfying the device size of the computing device 310 to be the outermost panel slots 114. For example, the user may select the first panel slot 114 and the second panel slot 114 that have the distance between the first panel slot 114 and the second panel slot 114 lower than the device length of the computing device 310 to be the outermost panel slots 114. In another example, the user may select the first panel slot 114 and the second panel slot 114 that have the distance between the first panel slot 114 and the second panel slot 114 within the range of [60% , 95%] of the device length of the computing device 310 to be the outermost panel slots 114. In some embodiments, the outermost panel slots 114 may be selected so that the center point of the base platform 112 is located midway between the outermost panel slots 114. This implementation is advantageous, because it improves the balance of the computing device 310 when the computing device 310 is situated on the device supporting panels 140 that are inserted into the outermost panel slots 114. In some embodiments, the user may select one or more panel slots 114 located between the outermost panel slots 114 to insert additional device supporting panels 140. These device supporting panels 140 may provide additional support for the computing device 310 when the computing device 310 is situated on these device supporting panels 140 and the device supporting panels 140 being inserted into the outermost panel slots 114, thereby improving the stability of the computing device 310.

In some embodiments, to assemble the base structure 110, in addition to constructing the base platform 112 from the plurality of platform portions 111 as discussed above, the user may position one or more front panel tabs 124 to align the one or more front panel tabs 124 with the one or more panel slots 114 on the base platform 112. As depicted in FIGS. 8A and 9, the front panel 120 may extend from the platform portion 111a of the base platform 112 and the front panel tabs 124 may extend from the front panel 120. In some embodiments, the user may fold the front panel tab 124 along the folding line 125, and position the front panel tab 124 perpendicular to the front panel 120 and aligned with the panel slot 114 on the base platform 112 as depicted in FIGS. 8A, 9, and 10. In some embodiments, the front panel tab 124 may include one or more folding lines 125 corresponding to one or more panel slots 114 of the base platform 112. Depending on the panel slots 114 being selected to insert the device supporting panels 140 for the stand assembly 100, the user may fold the front panel tab 124 along the folding line 125 corresponding to the selected panel slot 114, and align at least a portion of the front panel tab 124 with the selected panel slot 114 at the folding line 125.

In some embodiments, instead of folding the front panel tab 124 perpendicular to the front panel 120 at the folding line 125, the user may detachably couple the front panel tab 124 to the front panel 120 at a position aligned with the panel slot 114 using one or more coupling elements (e.g., engaging tab, snap fastener, magnetic fastener, etc.). As an example, the front panel tab 124 may be formed as an individual tab separate from the front panel 120, and the front panel 120 may include one or more receiving slots at one or more positions corresponding to the panel slots 114 of the base platform 112. In this example, the user may insert the front panel tab 124 into the receiving slot on the front panel 120 that is corresponding to the panel slot 114 selected for the device supporting panel 140, thereby aligning the front panel tab 124 with the selected panel slot 114. Other implementations for flexibly aligning the front panel tab 124 with the panel slot 114 of the base platform 112 are also possible and contemplated.

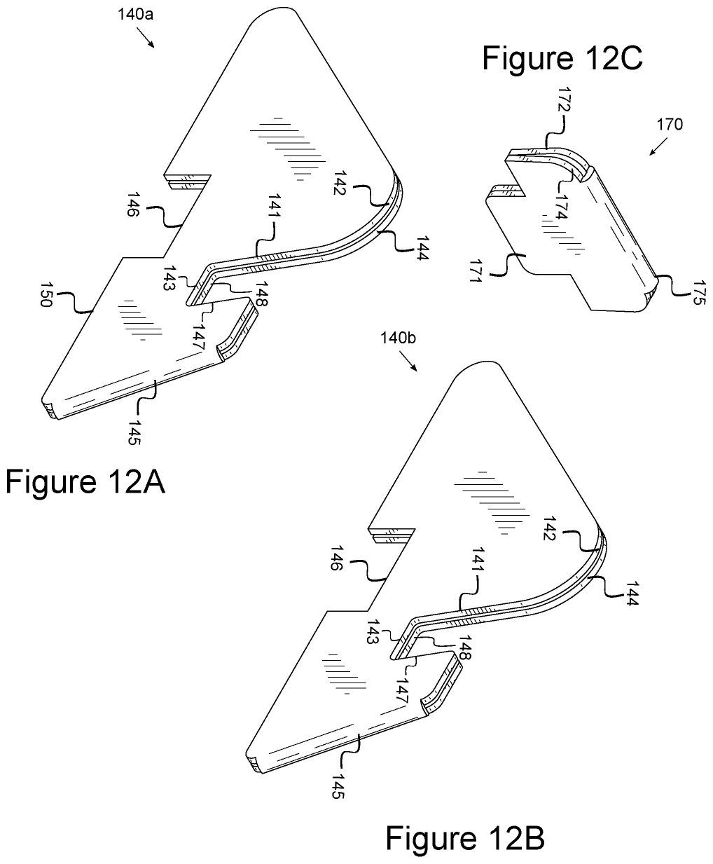

In some embodiments, once the base structure 110 is assembled, one or more device supporting panels 140 may be detachably coupled to the base structure 110 to form the stand assembly 100. The device supporting panel 140 in its assembled state is depicted in FIGS. 12A and 12B, and the device supporting panel 140 in its disassembled state is depicted in FIG. 8B. As depicted in FIG. 8B, the device supporting panel 140 may include a first portion 142 connected to a second portion 144, and the first portion 142 may be identical to the second portion 144. In some embodiments, the user may form the device supporting panel 140 in the assembled state by folding the device supporting panel 140 in the disassembled state along the folding line 145 so that the first portion 142 and the second portion 144 may overlap and rest against one another as depicted in FIGS. 12A and 12B.

As depicted in FIGS. 12A and 12B, the device supporting panel 140 may include the device slot 148 adapted to receive the computing device 310. In some embodiments, when the computing device 310 is situated in the device slot 148, at least a portion of the back surface of the computing device 310 may rest against the back surface 141 of the device slot 148, and at least a portion of the bottom edge of the computing device 310 may rest against the bottom surface 143 of the device slot 148 and/or the front surface147 of the device slot 148. As a result, the computing device 310 may be positioned at a predefined leaning angle when the computing device 310 is placed in the device slot 148 (e.g.,) 35°. In some embodiments, the leaning angle of the computing device 310 may be consistent throughout various physical activity surfaces on which the stand assembly 100 is situated. Therefore, the stand assembly 100 may be used as a carriage for the computing device 310 to position the computing device 310 at the predefined leaning angle in different contexts. In some embodiments, the device slot 148 may include one or more retaining elements positioned on one or more edges of the device slot 148. The retaining elements may include retaining material (e.g., rubber and/or other materials having a high friction coefficient), and the computing device 310 may be in contact with the retaining elements as the computing device 310 is situated in the device slot 148. In some embodiments, the retaining elements may increase the friction between the computing device 310 and the edges of the device slot 148, thereby preventing the computing device 310 from moving or sliding.

In some embodiments, the leaning angle at which the computing device 310 is placed in the device slot 148 may vary based on the position of the bottom edge of the computing device 310 relative to the bottom edge 143 of the device slot 148, and thus the tilt angle of the video capture device 320 may vary accordingly. In some embodiments, the bottom edge 143 of the device slot 148 may include one or more positioning elements corresponding to one or more leaning angles of the computing device 310. By positioning the bottom edge of the computing device 310 relative to the bottom edge 143 of the device slot 148 using these positioning elements, the leaning angle of the computing device 310 can be adjusted, thereby adjusting the tilt angle of the video capture device 320 and thus adjusting the field of view of the video capture device 320. As an example, the positioning elements may be protrusion ridges or indent channels located on the bottom edge 143 of the device slot 148, and the bottom edge of the computing device 310 may be situated against a protrusion ridge or within an indent channel to position the computing device 310 at the desired leaning angle. In this present disclosure, the top edge of the computing device 310 may refer to the edge of the computing device 310 that is proximate to the video capture device 320, and the bottom edge of the computing device 310 may be opposite to the top edge of the computing device 310.

In some embodiments, the device supporting panel 140 may have the back edge 141 of the device slot 148 being higher than the front edge 147 of the device slot 148. In some embodiments, the height dimension of the back edge 141 of the device slot 148 may satisfy a height threshold (e.g., higher than 7.5 cm). These implementations of the device slot 148 are advantageous, because they enable the stand assembly 100 to remain stable in case the center of gravity of the display positioning system 300 changes due to the computing device 310 being placed in the device slot 148. In some embodiments, additional weight may also be integrated into the stand assembly 100 (e.g., in the base platform 112) to improve its stability.

In some embodiments, the panel dimensions of the device supporting panel 140 may be specific to the panel type to which the device supporting panel 140 belongs. As discussed elsewhere herein, the panel type of the device supporting panel 140 may correspond to the device category of the computing device 310 that is placed in its device slot 148. In some embodiments, the computing devices 310 may be classified into the device category based on their device attributes. Non-limiting examples of the device attribute include, but are not limited to, brand name, type of device (e.g., mobile phone, tablet, etc.), device model (e.g., iPad Mini tablet, iPad Air tablet, iPad Pro tablet, etc.), device size (e.g., device length, device width, device height, distance between the camera and the bottom edge of the computing device, etc.), etc. As an example, the device attribute may be the brand name and the computing devices 310 may be classified into multiple device categories, each device category may be associated with a particular brand name (e.g., device category “Apple™,” device category “Samsung™,” etc.). In another example, the device attribute may be the type of device, and each device category may be associated with a particular type of device (e.g., device category “mobile phone,” device category “tablet,” etc.). In another example, the device attribute may be the device model, and each device category may be associated with a particular device model (e.g., device category “iPad Mini tablet,” device category “iPad Air tablet”, etc.). Other implementations of the device category are also possible and contemplated.

In some embodiments, for each panel type corresponding to a device category, the device supporting panel 140 of the panel type may have its panel dimensions being based on the device size of the computing devices 310 in the device category. Non-limiting examples of the panel dimensions include the depth dimension of the device slot 148, the height dimension of the back edge 141 of the device slot 148, the distance between the bottom edge 143 of the device slot 148 and the bottom edge 150 of the device supporting panel 140, etc. As an example, for a first computing device 310 belonging to a first device category (e.g., device category “Fire 7 tablet”), a first device supporting panel 140 of a first panel type corresponding to the first device category may have a first distance between the bottom edge 143 of the device slot 148 and the bottom edge 150 of the first device supporting panel 140 (e.g., 10 cm). For a second computing device 310 belonging to a second device category (e.g., device category “iPad Air tablet”), a second device supporting panel 140 of a second panel type corresponding to the second device category may have a second distance between the bottom edge 143 of the device slot 148 and the bottom edge 150 of the second device supporting panel 140 (e.g., 6 cm). The device size of the first computing device 310 may be different from the device size of the second computing device 310. For example, the first computing device 310 may have the device height of 20 cm while the second computing device 310 may have the device height of 24 cm.

In this example, because the panel dimension of the first device supporting panel 140 is based on the device size of the first computing device 310 in the first device category and the panel dimension of the second device supporting panel 140 is based on the device size of the second computing device 310 in the second device category, the distance between the video capture device 320 of the first computing device 310 and the physical activity surface when the first device supporting panel 140 is used to build the stand assembly 100 and support the first computing device 310 may be substantially equal to the distance between the video capture device 320 of the second computing device 310 and the physical activity surface when the second device supporting panel 140 is used to build the stand assembly 100 and support the second computing device 310, and these distances may be substantially equal to the predefined camera height (e.g., 29.5 cm). Thus, by using the device supporting panel 140 of the panel type corresponding to the computing device 310 to assemble the stand assembly 100, the stand assembly 100 may be adjusted to raise the video capture device 320 of various computing devices 310 to the same camera height relative to the physical activity surface, although the computing devices 310 may belong to different device categories and have different device attributes. Therefore, the video capture devices 320 of these computing devices 310 may have a similar field of view due to their similar camera positions. This implementation is advantageous, because it enables the same type of the video capture device 320 and the calibrator 502 to be implemented in the computing devices 310 belonging to different device categories (e.g., device category “Fire 7 tablet”, device category “Fire HD 8 tablet”, etc.), and thus the manufacturing cost of the computing devices 310 can be reduced.

In some embodiments, the device supporting panel 140 may include the panel marker 149 indicating the panel type of the device supporting panel 140. In some embodiments, the panel marker 149 may specify one or more device attributes of the device category corresponding to the panel type of the device supporting panel 140. In the above example, the panel marker 149 of the first device supporting panel 140 may be a label indicating “Fire 7” and the panel marker 149 of the second device supporting panel 140 may be a label indicating “iPad Air,” which are the device model of the computing devices 310 in the corresponding device category.

In some embodiments, the panel marker 149 may include dots, characters, symbols, images, objects, colors, etc., that can be incorporated in the device supporting panel 140. In some embodiments, the panel marker 149 may be positioned proximate to the bottom edge 150 of the device supporting panel 140, and may be located within the field of view of the video capture device 320 of the computing device 310 when the computing device 310 is placed on the device supporting panel 140. In some embodiments, the field of view of the video capture device 320 may be adjusted (e.g., by adaptively assembling the stand assembly 100 based on the computing device 310 and/or by using the camera adapter 330) to not only include the activity scene of the physical activity surface located proximate to the stand assembly 100, but also include a portion of the device supporting panel 140 of the stand assembly 100 that has the panel marker 149. As a result, the panel marker 149 may be captured by the video capture device 320 and thus may be depicted and detectable in the captured image. In some embodiments, the panel marker 149 detected in the captured image may be used to determine the stand configuration of the stand assembly 100. For example, the panel marker 149 may be used to determine the panel slot 114 in which the device supporting panel 140 is inserted, estimate the relative position of the device supporting panel 140 relative to other device supporting panels 140, determine the relative position of the device supporting panel 140 relative to other reference point associated with the stand assembly 100 (e.g., the visual indicator 122), etc. The implementation of the panel marker 149 is advantageous, because it enables the computing device 310 to determine the stand configuration of the stand assembly 100 (e.g., supporting panel positions, etc.) without requiring the user to input this data, and thus the user experience can be improved.

In some embodiments, the device supporting panel 140 may include the base slot 146 adapted to compatibly accommodate the base platform 112 when the device supporting panel 140 is inserted into the panel slot 114 on the base platform 112. In some embodiments, the base platform 112 in the assembled state may fit in the base slot 146, and thus the base slot 146 may retain the relative positions of the platform portions 111 that form the base platform 112, thereby maintaining the shape of the base platform 112 in its assembled state when the base platform 112 is accommodated in the base slot 146.

In some embodiments, to assemble the stand assembly 100 for placing the computing device 310, the user may select multiple panel slots 114 on the base platform 112 in which the distance between two outermost panel slots 114 may satisfy the device size of the computing device 310 as discussed elsewhere herein. The user may also select the device supporting panels 140 of the panel type corresponding to the device category of the computing device 310, and insert the selected device supporting panels 140 into the selected panel slots 114 to detachably couple the device supporting panels 140 to the base platform 112. In some embodiments, when the device supporting panels 140 are coupled to the base platform 112, the device supporting panels 140 may align with one another, and the device slots 148 of the device supporting panels 140 may be located in parallel. Thus, the device slots 148 of the device supporting panels 140 may form a stand channel in which the computing device 310 may be situated and collectively supported by the device supporting panels 140. In some embodiments, if the directly adjacent device supporting panels 140 rest against one another, the stand channel formed by the device supporting panels 140 may be a continuous channel. In further embodiments, if the directly adjacent device supporting panels 140 have a distance in between, the stand channel formed by the device supporting panels 140 may be a discontinuous channel. In some embodiments, the stand channel may be capable of receiving and positioning the computing device 310 that is covered in a protective case.

In some embodiments, instead of coupling multiple device supporting panels 140 to multiple panel slots 114 on the base platform 112 as discussed above, the user may insert one device supporting panel 140 into multiple panel slots 114. In some embodiments, the device supporting panel 140 may be divided into multiple portions at one or more folding points, and these portions may be flexibly rearranged relative to one another so that two or more portions of the device supporting panel 140 can be simultaneously inserted into the panel slots 114. In some embodiments, each portion of the device supporting panel 140 may include a device slot 148. When the portions of the device supporting panel 140 are rearranged so that a plurality of first portions of the device supporting panel 140 are inserted into the panel slots 114, the first portions of the device supporting panel 140 may align with one another, and the device slots 148 of the first portions may be located in parallel. Thus, the device slots 148 on multiple first portions of the same device supporting panel 140 may form the stand channel in which the computing device 310 may be situated and collectively supported by the first portions of the same device supporting panel 140.

In some embodiments, the user may insert one device supporting panel 140 into one panel slot 114, and the stand assembly 100 may include only one device supporting panel 140. In some embodiments, such device supporting panel 140 may have the length dimension satisfying a length dimension threshold (e.g., higher than 60% of the device size of the computing device 310) to support the computing device 310 in a stable manner when the computing device 310 is situated in the device slot 148 of the only device supporting panel 140 of the stand assembly 100.

In some embodiments, to couple a device supporting panel 140 with the base structure 110 to form the stand assembly 100, the user may position the first portion 142 and the second portion 144 of the device supporting panel 140 relative to the front panel tab 124 of the base structure 110 so that the first portion 142 and the second portion 144 may wrap around the front panel tab 124, and thus the front panel tab 124 may be situated between the first portion 142 and the second portion 144 of the device supporting panel 140. As discussed elsewhere herein, the front panel tab 124 may be positioned perpendicular to the front panel 120 and aligned with the panel slot 114 on the base platform 112 of the base structure 110 into which the device supporting panel 140 will be inserted. In some embodiments, once the front panel tab 124 is situated between the first portion 142 and the second portion 144 of the device supporting panel 140, the user may insert the first portion 142 and the second portion 144 of the device supporting panel 140 into the panel slot 114 on the base platform 112.

As discussed elsewhere herein, the device supporting panel 140 including the first portion 142 and the second portion 144 of may compatibly fit into the panel slot 114. Therefore, the panel slot 114 in which the device supporting panel 140 is inserted may hold the first portion 142 and the second portion 144 of the device supporting panel 140 against one another with the front panel tab 124 being sandwiched between the first portion 142 and the second portion 144 as depicted in FIG. 2. As discussed elsewhere herein, the front panel tab 124 may extend from the front panel 120 and may be positioned perpendicular to the front panel 120. By holding the front panel tab 124 between the first portion 142 and the second portion 144 of the device supporting panel 140 and coupling the device supporting panel 140 to the base platform 112 via the panel slot 114, the relative position between the front panel 120, the device supporting panel 140, and the base platform 112 can be maintained to form a stable structure of the stand assembly 100. In addition, as the front panel 120 may extend from the platform portion 111a of the base platform 112 and may further be coupled to the base platform 112 via the front panel tabs 124 and the device supporting panels 140 as discussed above, the front panel 120 may provide a counterbalance to the base platform 112 and the computing device 310 supported by the device supporting panels 140 that are assembled with the base platform 112. As a result of this structure, the stability of the stand assembly 100 and the computing device 310 situated on the stand assembly 100 can be improved.

In some embodiments, in addition to detachably coupling the device supporting panels 140 to the base structure 110 as discussed above, the user may also detachably couple the adapter support 170 to the base structure 110 to form the stand assembly 100. As depicted in FIGS. 8A and 9, the base platform 112 may include the slot 118 adapted to receive the adapter support 170. The adapter support 170 in its assembled state is depicted in FIG. 12C, and the adapter support 170 in its disassembled state is depicted in FIG. 8C. As depicted in FIG. 8C, the adapter support 170 may include a first portion 172 connected to a second portion 174, and the first portion 172 may be identical to the second portion 174. In some embodiments, the user may form the adapter support 170 in the assembled state by folding the adapter support 170 in the disassembled state along the folding line 175 so that the first portion 172 and the second portion 174 may overlap and rest against one another as depicted in FIG. 12C. As depicted in FIG. 12C, the adapter support 170 in the assembled state may include the tab 171 that is compatible with the slot 118 on the base platform 112. The user may insert the tab 171 of the adapter support 170 into the slot 118 of the base platform 112, thereby detachably coupling the adapter support 170 to the base platform 112 of the base structure 110. In some embodiments, when the adapter support 170 is assembled with the base platform 112, the adapter support 170 may extend from the top surface of the base platform 112 and may be perpendicular to the top surface of the base platform 112 as depicted in FIG. 1.

In some embodiments, the camera adapter 330 may be placed on the adapter support 170 when the camera adapter 330 is not in use. When the camera adapter 330 is placed on the adapter support 170, the adapter support 170 may be located within the slot 336 of the camera adapter 330, thereby maintaining the camera adapter 330 on the adapter support 170. In some embodiments, the adapter support 170 may compatibly fit in the slot 336 of the camera adapter 330 to secure the camera adapter 330 on the adapter support 170 due to the friction between the adapter support 170 and the edges of the slot 336. In some embodiments, the adapter support 170 may include magnetic material to magnetically couple to the corresponding magnetic material integrated in the camera adapter 330, thereby detachably securing the camera adapter 330 in place and preventing the camera adapter 330 from falling off the adapter support 170. The implementation of the adapter support 170 is advantageous, because it reduces the risk of the camera adapter 330 being loose and potentially separated from other components of the display positioning system 300 (e.g., lost, etc.) when the camera adapter 330 is not situated on the computing device 310 to adapt the video capture device 320.

In some embodiments, the stand assembly 100 may include the visual indicator 122 indicating the stand attributes of the stand assembly 100. In some embodiments, the visual indicator 122 may include dots, characters, symbols, images, objects, colors, etc., that can be incorporated in the stand assembly 100. As depicted in FIG. 1, the visual indicator 122 may be positioned on the front panel 120. It should be understood that the visual indicator 122 may be positioned on other components of the stand assembly 100 (e.g., the base platform 112, the device supporting panels 140, etc.).

In some embodiments, the visual indicator 122 may be located within the field of view of the video capture device 320 when the computing device 310 is situated in the device slots 148 of the device supporting panels 140 that form the stand assembly 100. For example, the field of view of the video capture device 320 may be adjusted (e.g., by adaptively assembling the stand assembly 100 based on the computing device 310 and/or by using the camera adapter 330) to include the activity scene located in front of the front panel 120 on the physical activity surface and also include at least a portion of the front panel 120 that has the visual indicator 122. As a result, the visual indicator 122 may be captured by the video capture device 320 of the computing device 310 and therefore may be depicted and detectable in the captured image. In some embodiments, the visual indicator 122 detected in the captured image may be used to determine the stand attributes of the stand assembly 100 (e.g., stand type, stand dimensions, etc.) and may be used as a reference point to determine the relative position of the stand components of the stand assembly 100 (e.g., the device supporting panels 140, etc.), etc. The implementation of the visual indicator 122 is advantageous, because it enables the computing device 310 to determine the stand attributes and/or the stand configuration of the stand assembly 100 (e.g., supporting panel positions, etc.) without requiring the user to input this data, and thus the user experience can be improved.

In some embodiments, the stand assembly 100 may include one or more retaining elements positioned on the bottom surface of the front panel 120 and/or the base platform 112. The retaining elements may include retaining material (e.g., rubber) to increase the friction between the stand assembly 100 and the physical activity surface, thereby preventing the stand assembly 100 from moving or sliding. In some embodiments, the stand assembly 100 may include one or more coupling elements positioned on the bottom surface of the front panel 120 and/or the base platform 112. The coupling elements may be compatible with a structural pattern on the physical activity surface and therefore coupleable to this structural pattern to position and retain the stand assembly 100 on the physical activity surface. For example, the coupling element may be a slot compatible with a car track platform.

In some embodiments, the stand assembly 100 may include a cabling channel through which various cables (e.g., charging cable, connecting cable, connecting components, etc.) may be fed and connected to the computing device 310 while the computing device 310 is situated on the stand assembly 100. For example, the cabling channel may include at least a portion of the base platform 112 in which the cables are contained, and a cable slot positioned on the front surface of the base platform 112 (e.g., the platform portion 111a) through which the cables may be connected to the computing device 310 situated on the device supporting panels 140. In some embodiments, the stand assembly 100 may also include magnetic material integrated into the front panel 120 and/or other components of the stand assembly 100, and thus the stand assembly 100 may be detachably coupled to or interact with one or more tangible objects. Other features of the stand assembly 100 are also possible and contemplated.

In some embodiments, the user may assemble the stand assembly 100 based on the set of assembling instructions, situate the stand assembly 100 on the physical activity surface, and place the computing device 310 on the stand assembly 100. For example, based on the sequential steps in the set of assembling instructions, the user may fold the platform portions 111 at the folding edges 113 to form the base platform 112. The user may select the panel slots 114 on the base platform 112 that satisfy the device size of the computing device 310, and position each front panel tab 124 perpendicular to the front panel 120 and aligned with a panel slot 114 from the selected panel slots 114. The user may select the device supporting panels 140 corresponding to the device category of the computing device 310, and fold each device supporting panel 140 along the folding line 145. For each device supporting panel 140, the user may wrap the device supporting panel 140 around a front panel tab 124 that is aligned with a panel slot 114 from the selected panel slots 114, and insert the device supporting panel 140 into the panel slot 114 to couple the device supporting panel 140 with the base platform 112. The user may fold the adapter support 170 along the folding line 175, and insert the adapter support 170 into the slot 118 on the base platform 112. In some embodiments, the user may assemble the stand components of the stand assembly 100 in different order. For example, the user may couple the adapter support 170 with the base platform 112 prior to coupling one or more device supporting panels 140 with the base platform 112 and vice versa. In some embodiments, the stand assembly 100 may be assembled manually by the user and/or automatically by an automated system (e.g., robot, motorized arms, etc.).

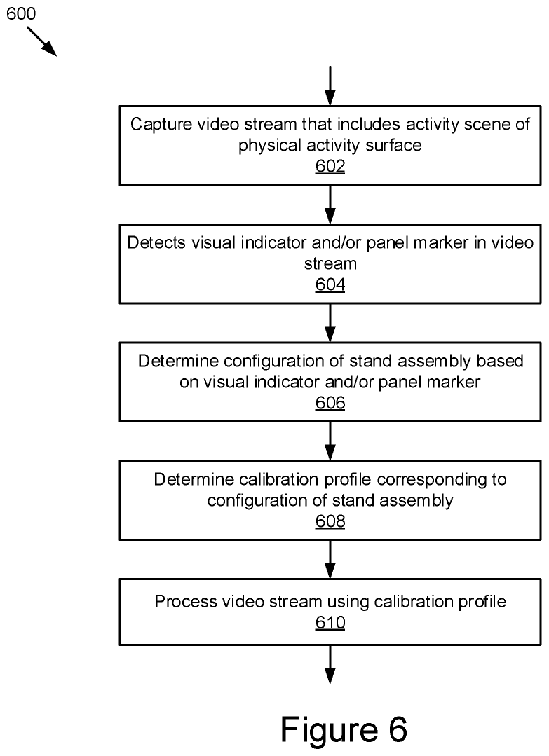

In some embodiments, the stand configuration in which the stand assembly 100 is constructed may impact the camera position at which the video capture device 320 of the computing device 310 may capture the video stream of the activity scene on the physical activity surface. Therefore, to accurately detect objects depicted in the video stream for the operations of the activity applications 414, the calibration of the images in the video stream may need to be adapted based on the stand configuration of the stand assembly 100. An example method 600 for processing the video stream is depicted in FIG. 6. In block 602, the video capture device 320 of the computing device 310 may capture the video stream that includes the activity scene of the physical activity surface and at least a portion of the stand assembly 100. As discussed elsewhere herein, the stand assembly 100 may be constructed with a stand configuration in which the device supporting panel 140 corresponding to the device category of the computing device 310 may be inserted into the panel slots 114 that satisfy the device size of the computing device 310. After being constructed, the stand assembly 100 may be placed on the physical activity surface, and the computing device 310 may be situated on the device supporting panels 140 of the stand assembly 100.

In block 604, the detector 504 may detect the visual indicator 122 and/or the panel markers 149 in the video stream. As discussed elsewhere herein, the visual indicator 122 may be positioned on the front panel 120 of the stand assembly 100 and may indicate the stand attributes and/or the stand configuration of the stand assembly 100. The panel marker 149 may be positioned on the device supporting panels 140 and may indicate the stand configuration of the stand assembly 100. In some embodiments, the detector 504 may apply an object detection algorithm to the image of the video stream to detect the visual indicator 122 on the front panel 120 and the panel markers 149 on the device supporting panels 140 that are depicted in the image, and match the visual indicator 122 and the panel markers 149 being detected to the object data describing various visual indicators and various panel markers in the storage 520.

In block 606, the calibrator 502 may determine the stand configuration of the stand assembly 100 based on the visual indicator 122 and/or the panel markers 149. To determine the stand configuration of the stand assembly 100, the calibrator 502 may determine the stand type (e.g., stand assembly for “Apple device”) and the stand dimensions of the stand assembly 100 based on the visual indicator 122. The calibrator 502 may also determine the panel type (e.g., device supporting panel for “iPad Air tablet”) and the panel dimensions of the device supporting panels 140 being used to assemble the stand assembly 100 based on the panel markers 149. In some embodiments, for each device supporting panel 140, the calibrator 502 may analyze the panel markers 149 and/or the visual indicator 122 detected in the video stream, and estimate the relative position of the device supporting panel 140 relative to other device supporting panels 140, the visual indicator 122, and/or other components of the stand assembly 100. The calibrator 502 may then determine the panel slot 114 of the base platform 112 into which the device supporting panel 140 is inserted based on these relative positions of the device supporting panel 140. In some embodiments, the calibrator 502 may also estimate the distance between the bottom edge of the computing device 310 and the front edge 147 of the device slot 148, and determine the relative position of the bottom edge of the computing device 310 relative to the bottom edge 143 of the device slot 148 of the device supporting panel 140.

In block 608, the calibrator 502 may determine a calibration profile based on the stand configuration of the stand assembly 100. As discussed elsewhere herein, the stand assembly 100 may be assembled using the device supporting panels 140 that correspond to the device category of the computing device 310 situated on the stand assembly 100 (e.g., device category “iPad Air”). Therefore, the calibrator 502 may analyze the stand configuration of the stand assembly 100, and determine the device category of the computing device 310 situated on the stand assembly 100 based on the panel type of the device supporting panels 140. The calibrator 502 may then determine the calibration profile associated with the device category of the computing device 310 in the storage 520. In some embodiments, the calibration profile may include calibration parameters for calibrating images captured by the video capture device 320 of the computing device 310 when the computing device 310 is situated on the stand assembly 100 in which the stand assembly 100 is assembled using the device supporting panels 140 corresponding to the device category of the computing device 310. In some embodiments, the calibration profile may include the distance parameter indicating the distance between the video capture device 320 and the physical activity surface, the tilt parameter indicating the tilt angle of the video capture device 320 relative to the horizontal line, etc. Other calibration parameters are also possible and contemplated.

In some embodiments, instead of being associated with the device category of the computing device 310, the calibration profile may be associated with a camera position of the video capture device 320 of the computing device 310 when the computing device 310 is situated on the stand assembly 100. Therefore, the calibrator 502 may determine the camera position of the video capture device 320 of the computing device 310 when the computing device 310 is situated on the stand assembly 100 based on the stand configuration of the stand assembly 100, and determine the calibration profile associated with this camera position in the storage 520.

In some embodiments, to determine the camera position of the video capture device 320 of the computing device 310, the calibrator 502 may determine the device model of the computing device 310 situated on the stand assembly 100. In some embodiments, the calibrator 502 may be implemented on the computing device 310 situated on the stand assembly 100. Therefore, the calibrator 502 may determine the device model of the computing device 310 situated on the stand assembly 100 to be the device model of the computing device 310 on which the calibrator 502 is implemented. Alternatively, the calibrator 502 may determine the device category of the computing device 310 situated on the stand assembly 100 based on the panel type of the device supporting panels 140 of the stand assembly 100 as discussed above, and determine the device model of the computing device 310 based on its device category. In some embodiments, the calibrator 502 may then determine the device attributes of the computing device 310 based on its device model. Non-limiting examples of the device attributes include the device length, the device height, the depth dimension of the device slot 148, the distance between the video capture device 320 and the bottom edge of the computing device 310, etc.

In some embodiments, the calibrator 502 may determine the camera position of the video capture device 320 based on the device attributes of the computing device 310 (e.g., the device dimensions the computing device 310, etc.) and the stand configuration of the stand assembly 100 (e.g., the panel dimensions of the device supporting panels 140, etc.). For example, the calibrator 502 may determine the camera height of the video capture device 320 to be the sum of the distance between the video capture device 320 and the bottom edge of the computing device 310 and the distance between the bottom edge 143 of the device slot 148 and the bottom edge 150 of the device supporting panel 140 (e.g., 30 cm). The calibrator 502 may also determine the tilt angle of the video capture device 320 based on the relative position of the bottom edge of the computing device 310 relative to the bottom edge 143 of the device slot 148 of the device supporting panel 140 (e.g.,) 35°. As discussed above, once the camera position of the video capture device 320 is determined, the calibrator 502 may determine the calibration profile associated with the camera position of the video capture device 320 in the storage 520.

In block 610, the calibrator 502 may process the video stream captured by the video capture device 320 using the calibration profile. In some embodiments, the calibrator 502 may apply one or more of the distance parameter, the tilt parameter, and/or other calibration parameters in the calibration profile to process the images in the video stream and detect one or more tangible objects in the video stream. As discussed elsewhere herein, the activity applications 414 may then use the tangible objects detected in the video stream to perform their operations.

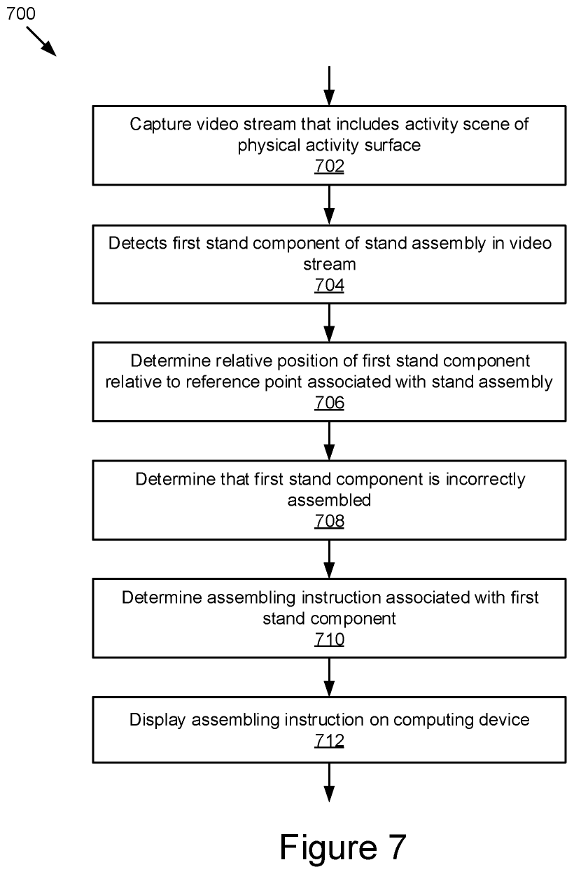

In some embodiments, the stand assembly 100 may need to be assembled in a correct manner to stably support the computing device 310 when the computing device 310 is situated on the stand assembly 100. An example method 700 for providing assembling instructions to facilitate the user in assembling the stand assembly 100 is depicted in FIG. 7. In block 702, the video capture device 320 of the computing device 310 may capture the video stream that includes the activity scene of the physical activity surface and at least a portion of the stand assembly 100. As discussed elsewhere herein, the stand assembly 100 may be constructed from a plurality of stand components that are detachably assembleable and these stand components may also be constructed from their disassembled state based on a set of assembling instructions. After being constructed, the stand assembly 100 may be placed on the physical activity surface, and the computing device 310 may be situated on the stand assembly 100.

In block 704, the detector 504 may detect a first stand component of the stand assembly 100 in the video stream. In some embodiments, the detector 504 may apply the object detection algorithm to the image of the video stream to detect one or more first stand components that form the stand assembly 100 and are depicted in the image (e.g., the front panel 120, the device supporting panels 140, the front surface of the base platform 112, etc.). The detector 504 may also detect the visual indicator 122 positioned on the front panel 120 and the panel markers 149 positioned on the device supporting panels 140 of the stand assembly 100.

In block 706, for each first stand component, the stand engine 540 may determine the relative position of the first stand component relative to a reference point associated with the stand assembly 100. The reference point associated with the stand assembly 100 may be the visual indicator 122 located on the front panel 120, the panel markers 149 located on the device supporting panels 140, and/or another stand component of the stand assembly 100, etc. In some embodiments, to determine the relative position of the first stand component, the stand engine 540 may estimate the distance between the first stand component and the reference point, and determine one or more second stand components to which the first stand component is coupled. As an example, the stand engine 540 may estimate the distance between a device supporting panel 140 and the visual indicator 122, and determine the panel slot 114 on the base platform 112 into which the device supporting panel 140 is inserted. In some embodiments, the stand engine 540 may also determine the component orientation of the first stand component in which the first stand component is positioned and assembled to form the stand assembly 100.

In block 708, the stand engine 540 may determine that the first stand component is incorrectly assembled based on the relative position and/or the component orientation of the first stand component. For example, the stand engine 540 may determine that the device supporting panel 140 is coupled to an incorrect panel slot 114, positioned upside down, etc. In another example, the stand engine 540 may determine that the panel tab 124 is positioned in an incorrect direction relative to the front panel 120, not wrapped around by device supporting panel 140, etc. In some embodiments, the stand engine 540 may compare the stand assembly 100 against the assembling model describing the correct structure of the stand assembly 100, and determine one or more stand components that are incorrectly assembled. Alternatively, in some embodiments, the stand engine 540 may determine that the device supporting panel 140 is coupled correctly to panel slot 114 and proceed to an activity launched by the activity application 414 without interrupting the user.

In block 710, the stand engine 540 may determine from the set of assembling instructions one or more assembling instructions associated with the first stand component being incorrectly assembled. For example, the device supporting panel 140 may be incorrectly assembled in the stand assembly 100, and the stand engine 540 may determine the assembling instructions associated with the device supporting panel 140 that describe how the device supporting panel 140 is assembled from its disassembled state and coupled to the front panel 120 and the base platform 112. In block 712, the stand engine 540 may display to the user of the computing device 310 the assembling instructions associated with the first stand component. For example, the stand engine 540 may display the assembling instructions associated with the first stand component on the display 530 of the computing device 310. The user may reference the assembling instructions, and correct the first stand component the stand assembly 100 based on the assembling instructions. Thus, by displaying the assembling instructions related to the stand component that is incorrectly assembled to the user on the computing device 310, the construction of the stand assembly 100 by the user can be facilitated.

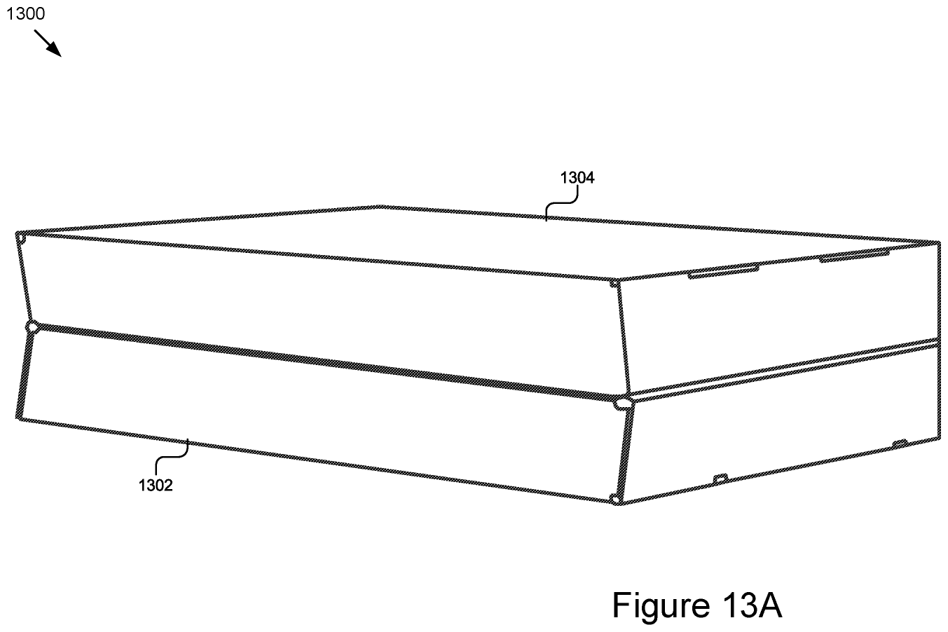

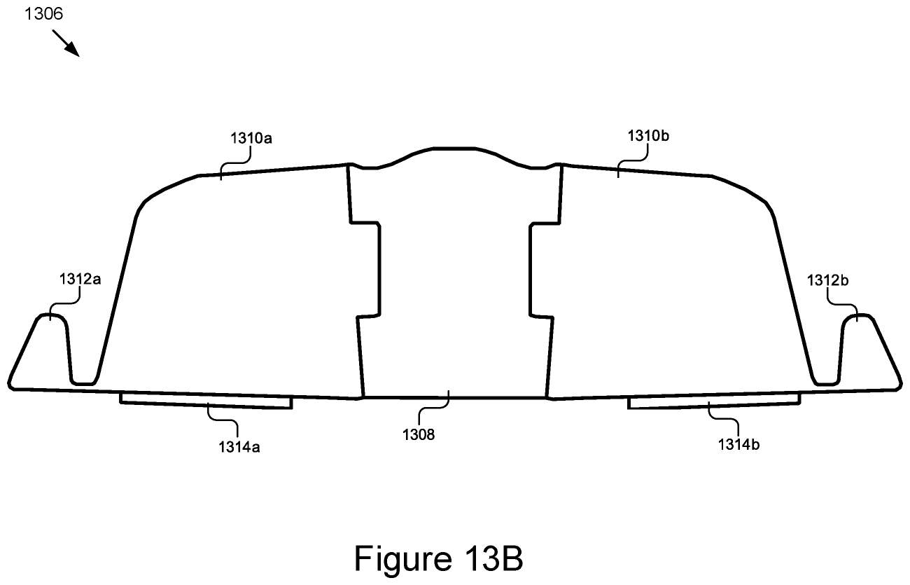

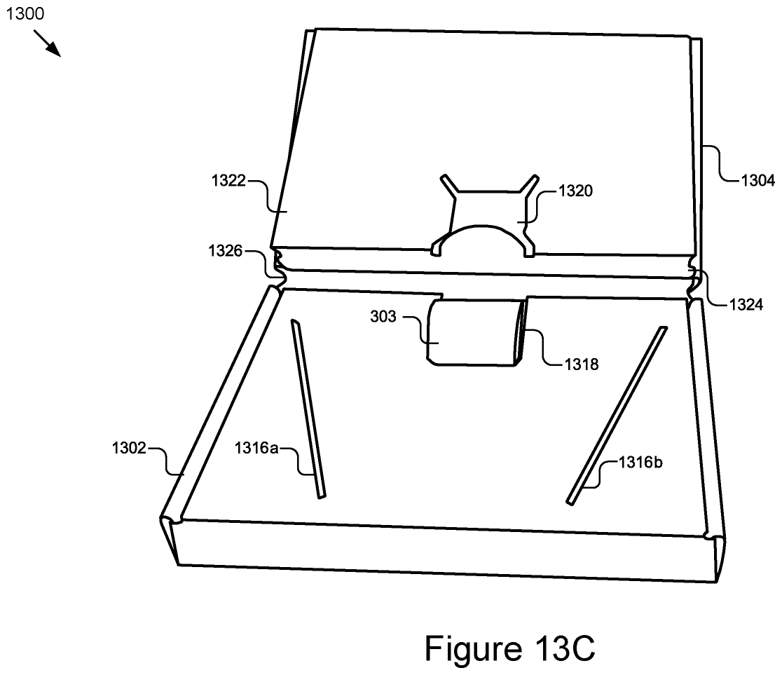

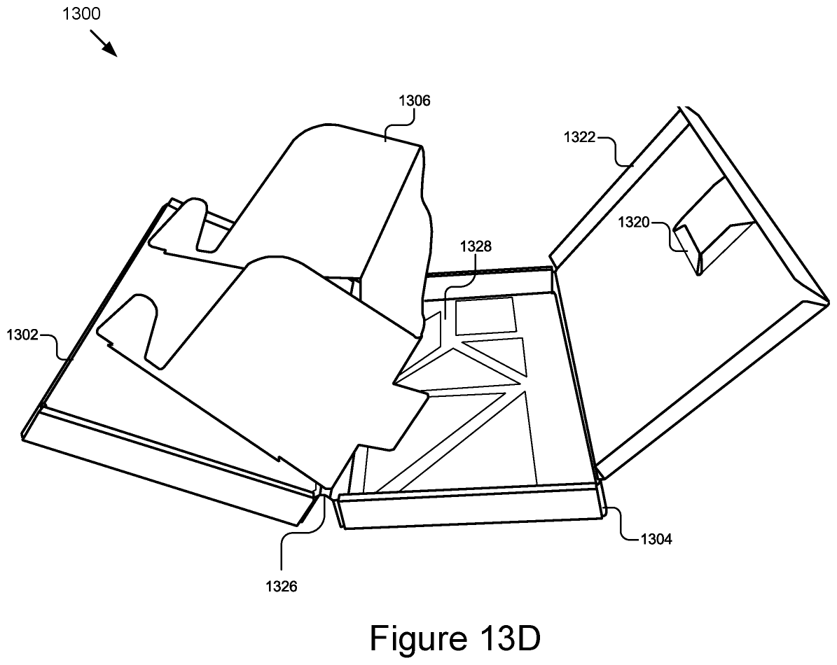

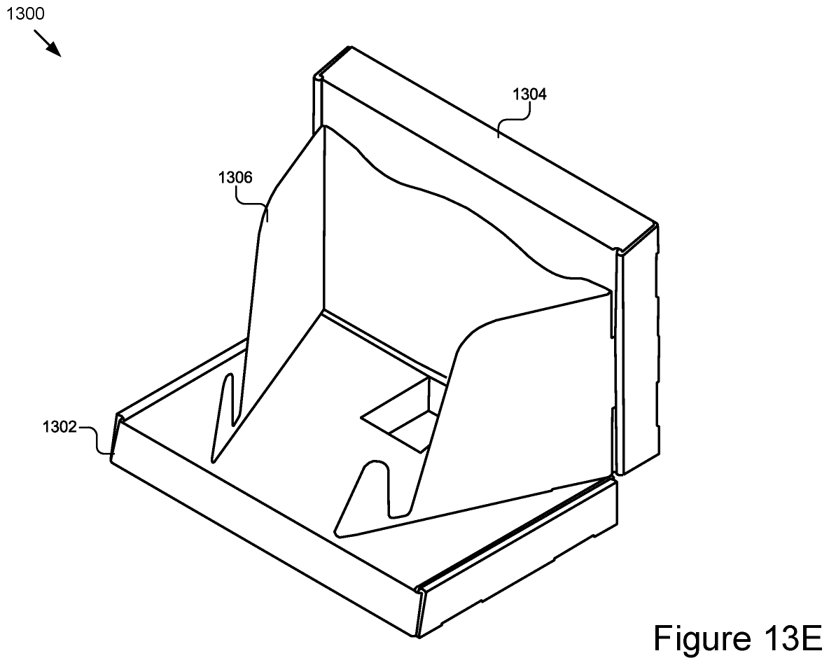

FIG. 13 shows another example embodiment of the stand assembly 100. This example of the stand assembly 1300 includes a top portion 1304 and a bottom portion 1302 of the stand assembly 1300. The top portion 1304 and the bottom portion 1302 may be connected by a hinge 1326 that connects the top portion 1304 and the bottom portion 1302 and allows them to rotate along the hinge 1326. The top portion 1304 and the bottom portion 1302 may be configured to rest together in a closed position as shown in FIG. 13A and all the stand assembly 1300 to form a box-like rectangular shape. In some embodiments, when the top portion 1304 and the bottom portion 1302 rest together in the closed position, the profile of the stand assembly 1300 is minimized to the shape of a book and is easily transportable, such as in a backpack. In further embodiments, when the stand assembly 1300 is in the closed position, it is the ideal shape to package and ship in large quantities at a lower cost to users, allowing the stand assembly 1300 to be cheaply and widely distributed.

FIG. 13B depicts a device supporting panel 1306 that has a similar function to the device supporting panel 140 described elsewhere herein. The device supporting panel 1306 may be formed out of a single piece of material and configure to be folded along edges to create one or more panel supporting faces 1310 and a back face 1308. The panel supporting faces 1310 include device supporting tabs 1312 that are designed to form a stand channel for the computing device to be supported in when the stand assembly 1300 is assembled as shown in FIG. 13E. The device supporting panel 1306 may include positioning tabs 1314 that extend out of the bottom edge of the panel supporting face 1310. The positioning tabs 1314 may be positioned within the positioning tab slots 1316 shown in FIG. 13C to support the device supporting panel 1306 in the stand assembly 1300.

FIG. 13C depicts the stand assembly 1300 in an open position where the top portion 1304 has been rotated along the hinge 1326 to expose the interior of the stand assembly 1300. As shown, the inside portion of the top portion 1304 may include a lid 1322 that can be opened and closed to reveal interior contents using the tabs 1324 to retain the lid in the closed position, as shown in FIG. 13D. The lid 1322 may retain one or more tangible objects 1322 and/or the device supporting panel 1306 when not in use. In some embodiments, the lid 1322 may include an adapter cutout 1320 that is configured to retain a camera adapter 303 in a camera adapter slot 1318 when the stand assembly 1300 is in the closed position. In some implementations, the camera adapter 303 when positioned in the camera adapter slot 1318 may extend above the surface of the bottom portion and the adapter cutout 1320 may allow the top portion to close around the extended portion of the camera adapter 303 when the stand assembly is in the closed position.

As shown in FIG. 13C, the bottom portion 1302 may further include positioning tab slots 1316 that are configured to retain the device supporting panel 1306 when the positioning tabs 1314 are positioned within the positioning tab slots 1316 as shown in FIG. 13D. FIG. 13D depicts the stand assembly 1300 in a partially assembled state. The device supporting panel 1306 is positioned one the interior surface of the bottom portion 1302. The lid 1322 is in the open position to expose a storage area that may include one or more tangible objects 1328 that a user may interact with as described elsewhere herein. By including the storage area, all of the components of the stand assembly and/or the tangible objects 1328 may be stored within the storage area and the stand assembly can be transported and/or shipped without risking loss and/or damage to the individual components.

As shown in FIG. 13E, the stand assembly 1300 may be assembled by inserting one or more tabs that extend out from a back side of the device supporting panel 1306 into corresponding slots on the top portion 1304 to create a stable stand for positioning a computing device as described elsewhere herein. In some embodiments, different sizes of the device supporting panel 1306 may be used with different types of computing devices as describe elsewhere herein to allow different computing devices with different camera parameters to all interact with the same stand assembly. It should be understood that the depicted examples of the stand assembly 100 and 1300 are provided by way of illustration and numerous other variations of stand assemblies are contemplated that allow multiple components to be assembled to position a computing device.

It should be understood that the above-described example activities are provided by way of illustration and not limitation and that numerous additional use cases are contemplated and encompassed by the present disclosure. In the above description, for purposes of explanation, numerous specific details are set forth in order to provide a thorough understanding of the present disclosure. However, it should be understood that the technology described herein may be practiced without these specific details. Further, various systems, devices, and structures are shown in block diagram form in order to avoid obscuring the description. For instance, various implementations are described as having particular hardware, software, and user interfaces. However, the present disclosure applies to any type of computing device that can receive data and commands, and to any peripheral devices providing services.

In some instances, various implementations may be presented herein in terms of algorithms and symbolic representations of operations on data bits within a computer memory. An algorithm is here, and generally, conceived to be a self-consistent set of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout this disclosure, discussions utilizing terms including “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Various implementations described herein may relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, including, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The technology described herein can take the form of a hardware implementation, a software implementation, or implementations containing both hardware and software elements. For instance, the technology may be implemented in software, which includes but is not limited to firmware, resident software, microcode, etc. Furthermore, the technology can take the form of a computer program product accessible from a computer-usable or computer-readable medium providing program code for use by or in connection with a computer or any instruction execution system. For the purposes of this description, a computer-usable or computer readable medium can be any non-transitory storage apparatus that can contain, store, communicate, propagate, or transport the program for use by or in connection with the instruction execution system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories that provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems, storage devices, remote printers, etc., through intervening private and/or public networks. Wireless (e.g., Wi-Fi™) transceivers, Ethernet adapters, and modems, are just a few examples of network adapters. The private and public networks may have any number of configurations and/or topologies. Data may be transmitted between these devices via the networks using a variety of different communication protocols including, for example, various Internet layer, transport layer, or application layer protocols. For example, data may be transmitted via the networks using transmission control protocol/Internet protocol (TCP/IP), user datagram protocol (UDP), transmission control protocol (TCP), hypertext transfer protocol (HTTP), secure hypertext transfer protocol (HTTPS), dynamic adaptive streaming over HTTP (DASH), real-time streaming protocol (RTSP), real-time transport protocol (RTP) and the real-time transport control protocol (RTCP), voice over Internet protocol (VOIP), file transfer protocol (FTP), WebSocket (WS), wireless access protocol (WAP), various messaging protocols (SMS, MMS, XMS, IMAP, SMTP, POP, WebDAV, etc.), or other known protocols.

Finally, the structure, algorithms, and/or interfaces presented herein are not inherently related to any particular computer or other apparatus. Various general-purpose systems may be used with programs in accordance with the teachings herein, or it may prove convenient to construct more specialized apparatus to perform the required method blocks. The required structure for a variety of these systems will appear from the description above. In addition, the specification is not described with reference to any particular programming language. It will be appreciated that a variety of programming languages may be used to implement the teachings of the specification as described herein.

The foregoing description has been presented for the purposes of illustration and description. It is not intended to be exhaustive or to limit the specification to the precise form disclosed. Many modifications and variations are possible in light of the above teaching. It is intended that the scope of the disclosure be limited not by this detailed description, but rather by the claims of this application. As will be understood by those familiar with the art, the specification may be embodied in other specific forms without departing from the spirit or essential characteristics thereof. Likewise, the particular naming and division of the modules, routines, features, attributes, methodologies and other aspects are not mandatory or significant, and the mechanisms that implement the specification or its features may have different names, divisions and/or formats.

Furthermore, the modules, routines, features, attributes, methodologies and other aspects of the disclosure can be implemented as software, hardware, firmware, or any combination of the foregoing. Also, wherever a component, an example of which is a module, of the specification is implemented as software, the component can be implemented as a standalone program, as part of a larger program, as a plurality of separate programs, as a statically or dynamically linked library, as a kernel loadable module, as a device driver, and/or in every and any other way known now or in the future. Additionally, the disclosure is in no way limited to implementation in any specific programming language, or for any specific operating system or environment. Accordingly, the disclosure is intended to be illustrative, but not limiting, of the scope of the subject matter set forth in the following claims.

What is claimed is:

1. A stand assembly comprising:
a base structure including one or more foldable base components that are detachably assembleable to form the base structure; and
one or more foldable device supporting panels detachably coupleable to the base structure, a device supporting panel from the one or more foldable device supporting panels including a device slot adapted to receive a computing device.

2. The stand assembly of claim 1, wherein the one or more foldable base components of the base structure include:
a plurality of platform portions including at least a first platform portion detachably coupleable to a second platform portion to form a base platform from the plurality of platform portions, the base platform including one or more panel slots adapted to receive the one or more device supporting panels.

3. The stand assembly of claim 2, wherein:
the device supporting panel includes a base slot adapted to compatibly accommodate the base platform when the device supporting panel is inserted into a panel slot on the base platform; and
the base slot of the device supporting panel retains a relative position between the plurality of platform portions of the base platform when the base platform is accommodated in the base slot.

4. The stand assembly of claim 2, wherein:
the second platform portion includes a gripping slot aligned with a panel slot from the one or more panel slots, the gripping slot and the panel slot retaining the device supporting panel in the panel slot when the device supporting panel is inserted into the panel slot.

5. The stand assembly of claim 1, wherein the one or more foldable base components of the base structure include:
a front panel extending from a platform portion of a base platform; and
a visual indicator positioned on the front panel and located within a field of view of a video capture device of the computing device when the computing device is situated in one or more device slots of the one or more device supporting panels.

6. The stand assembly of claim 1, wherein the one or more foldable base components of the base structure include:
a front panel extending from a platform portion of a base platform; and
a front panel tab extending from the front panel and positionable to align with a panel slot on the base platform.

7. The stand assembly of claim 6, wherein:
the front panel tab is situated between a first portion and a second portion of the device supporting panel when the device supporting panel is inserted into the panel slot on the base platform and the panel slot on the base platform holds the first portion and the second portion of the device supporting panel against one another.

8. The stand assembly of claim 1, wherein:
the device supporting panel has a back surface of the device slot that is higher than a front surface of the device slot; and
at least a portion of a back surface of the computing device rests against the back surface of the device slot and at least a portion of a device edge of the computing device rest against one or more of a bottom surface of the device slot and the front surface of the device slot when the computing device is situated in the device slot.

9. The stand assembly of claim 1, wherein:
the device slot of the device supporting panel includes a retaining element positioned on an edge of the device slot, the retaining element including a retaining material.

10. The stand assembly of claim 1, wherein:
the base structure includes a slot adapted to receive an adapter support; and
the adapter support is located within a slot of a camera adapter when the camera adapter is placed on the adapter support.

11. The stand assembly of claim 10, wherein:
the adapter support compatibly fits in the slot of the camera adapter.

12. The stand assembly of claim 1, wherein:
the one or more foldable base components of the base structure and the one or more device supporting panels are made of one or more of cardboard, paperboard, and plastic.

13. A method comprising:
capturing, using a video capture device of a computing device, a video stream that includes an activity scene of a physical activity surface, the computing device being placed on a stand assembly situated on the physical activity surface;
detecting in the video stream, using a detector executable on the computing device, a first stand component of the stand assembly;
determining a relative position of the first stand component of the stand assembly relative to a reference point associated with the stand assembly;
determining that the first stand component is incorrectly assembled based on the relative position of the first stand component relative to the reference point;
determining an assembling instruction associated with of the first stand component; and
displaying the assembling instruction on the computing device.

14. The method of claim 13, wherein:
the stand assembly includes a plurality of stand components that are detachably assembleable to form the stand assembly based on a set of assembling instructions.

15. The method of claim 13, wherein the reference point associated with the stand assembly includes one or more of:
a second stand component of the stand assembly;
a visual indicator positioned on a front panel of the stand assembly; and
a panel marker positioned on a device supporting panel of the stand assembly.

16. The method of claim 13, further comprising:
determining a component orientation of the first stand component; and wherein
determining that the first stand component is incorrectly assembled is further based on the component orientation of the first stand component.

17. A foldable stand assembly comprising:
a base structure including a foldable base platform, the foldable base platform including a first panel slot and a second panel slot;
a first foldable device supporting panel adapted to be inserted into the first panel slot of the foldable base platform to form the foldable stand assembly; and
a second foldable device supporting panel adapted to be inserted into the second panel slot of the foldable base platform to form the foldable stand assembly.

18. The foldable stand assembly of claim 17, wherein the base structure includes:
a first panel tab on the base structure, the first panel tab configured to be situated between a first portion and a second portion of the first device supporting panel when the first device supporting panel is inserted into the first panel slot; and
a second panel tab on the base structure, the second panel tab configured to be situated between a first portion and a second portion of the second device supporting panel when the second device supporting panel is inserted into the second panel slot.

19. The foldable stand assembly of claim 17, wherein the first foldable device panel and the second foldable device panel form a device slot adapted to receive a stably position a bottom edge of a computing device.

20. The foldable stand assembly of claim 17, wherein:
the plurality of foldable stand components of the foldable stand assembly are made of one or more of cardboard, paperboard, and plastic.
